(19) United States
(12) Patent Application Publication
(10) Pub. No.: US 2019/0232409 A1
(43) Pub. Date: Aug. 1, 2019

(54) BONDED ASSEMBLY OF DISSIMILAR MATERIALS AND METHOD OF MANUFACTURE OF THE SAME

(71) Applicant: John James Barry, Ennis (IE)

(72) Inventor: John James Barry, Ennis (IE)

(21) Appl. No.: 16/312,099

(22) PCT Filed: Jun. 26, 2017
(86) PCT No.: PCT/IE2017/000012

§ 371 Date: Dec. 20, 2018

Related U.S. Application Data
(60) Provisional application No. 62/354,695, filed on Jun. 25, 2016.
(60) Provisional application No. 62/421,267, filed on Nov. 12, 2016.

(30) Foreign Application Priority Data
Jul. 5, 2016 (GB) 1611743.4

(51) Int. Cl. B23K 1/00; B23K 1/20

(52) U.S. Cl. CPC B23K 1/0008; B23K 1/19; B23K 1/20

(57) ABSTRACT

The disclosure relates to bonded assemblies (89) and a method of manufacture of such bonded assemblies (89). A such bonded assembly (89) has low residual stress and includes an inner body (91) having a substantially conical form, an outer body (90) having a substantially conical recess and a bonding region; whereby the conical form is in a first material having a thermal expansion coefficient al and the conical recess is in a second material having a thermal expansion coefficient a2 whereby al is not equal to a2; whereby said conical form includes an axis (31) extending in an axial direction and is substantially concentric with said conical recess; said bonding region including at least a third material having a plurality of grains and with an alignment of said grains relative to the generatrices of said conical form and said conical recess; said related method including an axial displacement of said inner body (91) relative to said outer body (90) simultaneous with cooling of said bonded assembly (89) from an elevated temperature to a low or ambient temperature.

### FIELD OF THE INVENTION

The present disclosure relates to bonded assemblies and a bonding method; said assemblies including joints between materials with different coefficients of thermal expansion characterised by low residual stresses and high precision.

### BACKGROUND TO THE INVENTION

Brazing processes provide a strong metallurgical bond between component parts. The strength of a butt joint for example may exceed the strength of the bulk braze alloy by as much as a factor of about three. Braze joints may also exhibit considerable ductility; shear deformations of 163% and 120% have been measured in metallographic cross sections of lap joints between stainless steel bodies with silver or silver-copper braze layers which were loaded and deformed at ambient temperature (NASA/TM-2011-215876). Etchants may accentuate the microstructure of the braze alloy including plastic flow lines; example of etchants are in ASTM E407.

Brazing processes are important in the bonding of metals and ceramics. Polycrystalline diamond (PCD), cemented carbide, sintered alumina and sintered silicon nitride are examples of composite ceramics. PCD is sintered under ultra-high pressures and temperatures and provided with an integrally bonded support layer of cemented carbide which facilitates brazing. When joining cemented carbide, either to another cemented carbide body or to a metal alloy body, it is common to use alloys including silver, copper and zinc—so called “silver” brazes. ISO17672 lists brazing alloys, many of which are used with a flux. The use of “active” brazing alloys has become commonplace for many technical ceramics and diamond which are not ‘wet’ by conventional silver braze alloys. It is also often desirable to join a ceramic material having one combination of properties with a metallic material having another combination of properties. Ceramic materials however, generally exhibit coefficients of thermal expansion considerably lower than those of most metals and alloys and this is problematic when such materials are brazed due the formation of residual stresses. Large residual stresses are undesirable as they limit the maximum tolerable loads during service and or result in cracking of the ceramic material or cohesive or tensile failure of the braze layer.

A braze joint may a certain minimum thickness so as to permit adequate flow of the braze alloy and wetting of the entire joint area. Some joints include so-called “tri-foil” or sandwich brazes which comprise a central copper or other compliant metallic foil, sandwiched between two layers of braze alloy. These help to moderate residual stresses and have been found useful when brazing parts where the largest braze dimension is greater than 10-20 mm for example. Thickening the braze joint may provide a similar result. A drawback of both approaches is reduced strength of the braze joint.

GB1140122 describes a braze geometry. In FIG. 1, an aluminium tube (1) has a truncated conical end with an end-face (2) and within a mating steel tube (3), a similarly sized conical recess with an internal square shoulder (4). The end-face (2) of the truncated cone and the internal shoulder (4) are sized such that at ambient temperature with a layer of braze alloy (5) in position, clearance (6) exists between the opposing faces, while at brazing temperature, the differential thermal expansion of the two materials ensure the proper amount of clearance for the braze alloy. The two tubes are pushed together prior to the braze alloy solidifying. The dissimilar thermal expansion coefficients of aluminium and steel alloys will result in significant residual stresses. JPS6453765 describes a similar method in which the assembly is simultaneously heated and compressed in an axial direction. DE202006010498 describes another conical joint.

EP0311428 discloses a method for joining materials with different thermal expansion coefficients. In FIG. 2, the taper on the ceramic body (7) near the braze joint (8) with the metal body (9) is claimed to reduce cracking. EP1813829B1 describes a braze joint between a ceramic shaft (10) and a steel shaft (11). In FIG. 3, the end of the ceramic shaft is received in the conical recess (12) in (11). Within the more central region (13), a larger gap exists than at the distal region (14) and the proximal region where the surfaces of (10) and (11) engage so as to maintain alignment during the brazing process. With reference to FIG. 4, US2015/0198040 describes a conical braze joint for silicon-cemented diamond (SCD) (16) and cemented carbide (16). The prior art relating to conical joints does not provide a means of reducing residual stresses.

There is a need therefore, for a means by which to braze components of materials having dissimilar coefficients of thermal expansion which provides for low residual stresses and or whereby cohesive and or tensile failure in the braze layer and or cracking of the brazed components is avoided. A high degree of geometrical precision is also desirable.

### BRIEF SUMMARY OF THE INVENTION

The present invention provides for bonded assemblies including materials with dissimilar coefficients of thermal expansion and a method for making same and is particularly defined in the appended claims which are incorporated into this description by reference and for the purposes of economy of presentation are not produced verbatim in the description.

### BRIEF DESCRIPTION OF THE DRAWINGS

FIGS. 1 to 4 show brazed assemblies including dissimilar materials in accordance with prior art GB1140122, EP0311428, EP1813829B1 and US2015/0198040.

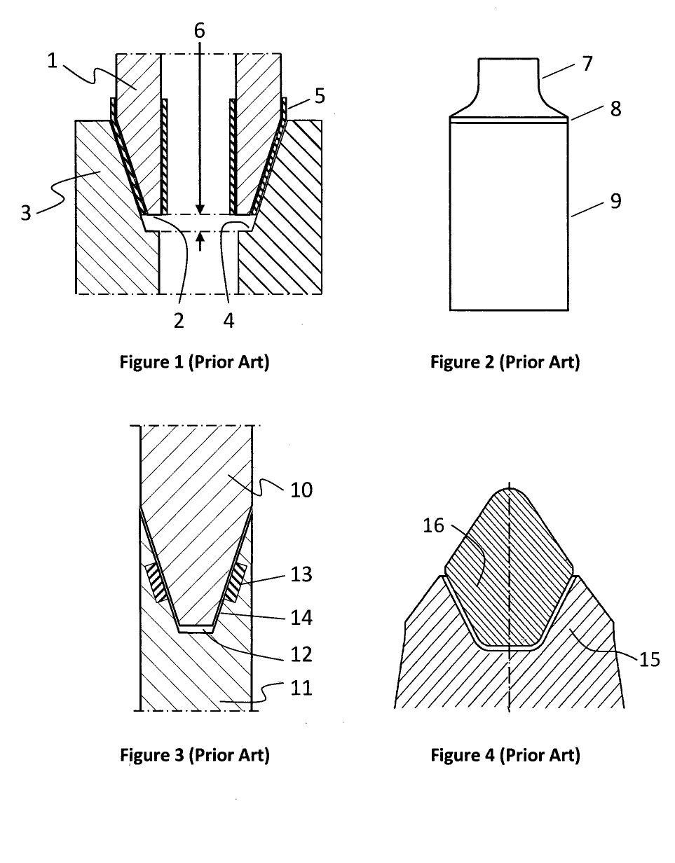

FIGS. 5 to 7 show brazed assemblies which are not in accordance with the present invention.

FIGS. 8 and 9 illustrate geometry in accordance with the present disclosure.

FIGS. 10 and 11 depict relationships between certain parameters in embodiments in accordance with the present disclosure.

FIG. 12 illustrates geometry in accordance with the present disclosure.

FIG. 13 depicts relationships between certain parameters in embodiments in accordance with the present disclosure.

FIG. 14 depicts thermal expansion of a body of laminate construction including polycrystalline diamond and cemented carbide.

FIG. 15 depicts an embodiment of the present disclosure including a body of laminate construction.

FIG. 16 depicts certain characteristics of braze regions and certain parameters derived therefrom, as relate to embodiments of the present disclosure.

FIG. 17 depicts the mode of plastic deformation relating to braze regions in accordance with the present disclosure.

FIG. 18 depicts geometry in accordance with the present disclosure.

FIGS. 19 to 23 depict characteristics of braze region microstructures; all in accordance with the present disclosure.

FIGS. 24 to 27 depict embodiments of the present disclosure characterised by low residual stresses.

FIGS. 28 and 29 depict embodiments of the present disclosure providing improved geometrical precision.

FIG. 30 illustrates braze regions in example embodiments of the present disclosure.

### DETAILED DESCRIPTION OF THE INVENTION

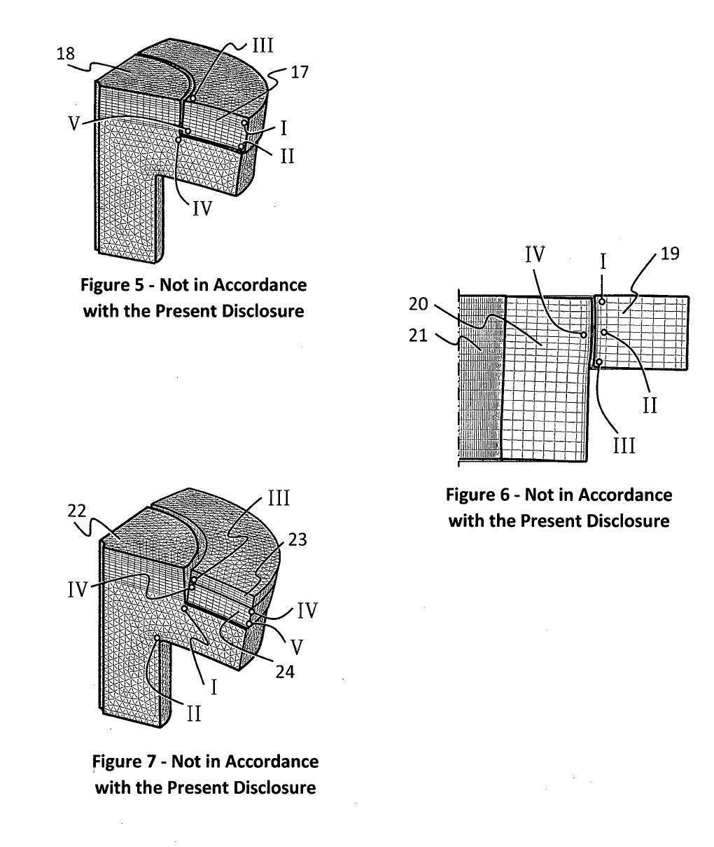

By way of illustration of the limitations of the prior art, FIG. 5 depicts a quadrant of a rotationally symmetrical brazed assembly which is not in accordance with the present disclosure, illustrating the mode of thermal deformation (exaggerated for ease of visualisation) upon cooling to ambient temperature. The outer body (17) of silicon nitride is brazed to the inner body (18) of structural steel. The properties of the materials are provided in Table 1, in which the thermal expansion values represent the mean linear coefficient over the temperature range of interest. The residual ‘hoop’ (σ_{H}), ‘radial’ (σ_{R}) and ‘axial’ (σ_{A}) stresses in the brazed assembly were determined using finite element analysis (FEA) where the assembly cools over a temperature range of 400° C. The predicted modes of deformation are in agreement with experience. The hoop stress at positions I, II and V in FIG. 5 is −347 MPa, −780 MPa and −1130 MPa respectively. The radial stress at positions III and IV is 991 MPa and 324 MPa respectively. Such stresses will adversely affect the performance of the assembly.

By way of illustration of the limitations of the prior art, FIG. 6 depicts a half-section of a rotationally symmetrical brazed assembly which is not in accordance with the present disclosure, illustrating it's mode of thermal deformation. The brazed assembly comprises a silicon nitride outer body (19) and a central steel shaft (20) with a bore (21). In FIG. 6, excessive residual stresses occur at positions I (σ_{R}=819 MPa), II (σ_{A}=−384 MPa, σ_{H}=−840 MPa), III (σ_{R}=1011 MPa) and IV (σ_{R}=365 MPa, σ_{A}=356 MPa, σ_{H}=519 MPa). FIG. 7 depicts a quadrant of a rotationally symmetrical brazed assembly which is not in accordance with the present disclosure illustrating it's mode of thermal deformation. The brazed assembly includes a PCD composite wherein a PCD layer (23) is integrally bonded to a cemented carbide support layer (24); the support layer (24) brazed to a steel shaft (22). The axial stress (σ_{A}) at positions III, IV and V is 325 MPa, −239 MPa and 279 MPa respectively. The hoop stress (σ_{H}) at position III is −1344 MPa. The radial stress (σ_{R}) at positions I, II and VI is 522 MPa, 347 MPa and 204 MPa respectively. Stresses of this magnitude are sufficient to at least initiate cracking in the cemented carbide and to result in cohesive and shear failure within the braze layer.

TABLE 1

| | Youngs | | |
|---|---|---|---|
| | Modulus | Coefficint of Thermal | Poisson's |
| | (GPa) | Expansion (K⁻¹) | Ratio |
| Silicon Nitride | 300 | 3.4e−6 | 0.28 |
| Steel | 220 | 12.5e−6 | 0.30 |
| PCD | 900 | 3.5e−6 | 0.12 |
| Cemented Carbide | 600 | 6.5e−6 | 0.21 |
| Braze Alloy | 20-50 | 19.0e−6 | 0.31 |

The present invention broadly provides for bonded assemblies including a bonding region; said bonded assembly produced by a bonding process involving the heating of said bonded assembly to a maximum process temperature and subsequent deformation of said bonding region of said bonded assembly over a temperature interval ΔT where ΔT extends from an elevated temperature to a low or ambient temperature. Said bonded assemblies include at least a first material, a second material and a third material; at least said first material and said second material having different coefficients of thermal expansion and whereby said third material apposes and is metallurgically bonded both to said first material and to said second material. There are at least two classes of embodiments of the present disclosure; the first class of embodiment includes a third material which melts and resolidifies during said bonding process, such materials exemplified in ISO17672 for example—said bonding process may therefore be a brazing process. The second class of embodiment of the present disclosure includes a third material which remains substantially as a solid phase throughout said bonding process which may be a diffusion bonding process. The essential features of the present disclosure do not differ between these two classes of embodiments and for economy of presentation, where this disclosure describes processes, alloys, features, characteristics, assemblies or regions relating to any aspect of a “braze” or a “braze” layer, the disclosure will equally apply to any aspect of a “bond” or a “bonding layers”.

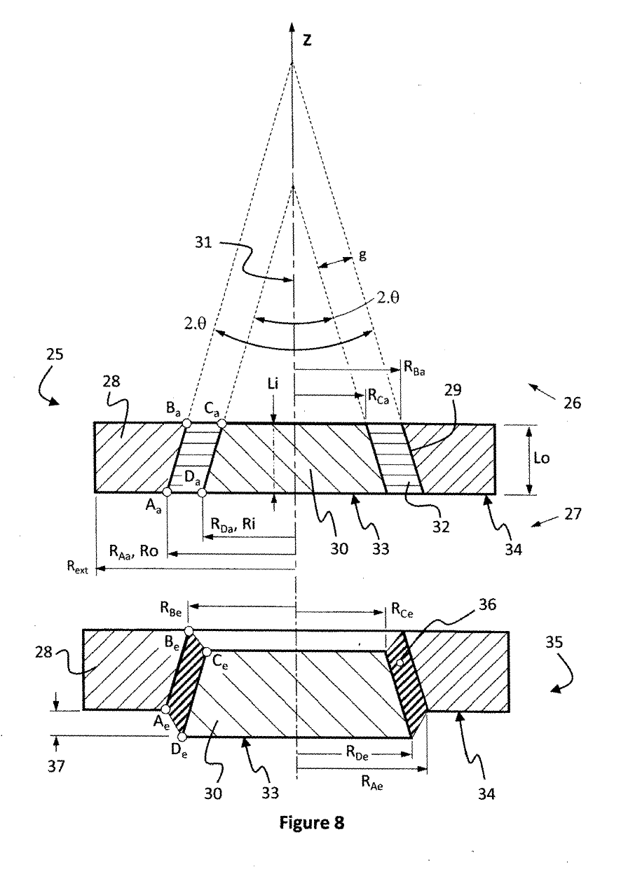

FIG. 8 depicts an embodiment of the present disclosure in cross section. The brazed assembly (25) has a forward end (26) and a rearward end (27) and includes an outer body (28) including a conical frustrum recess (29) and an inner body (30) including a conical frustrum form. The inner and outer bodies are substantially rotationally symmetric about the axis (31) in the Z direction and are separated by a braze region (32) of width g which contains a braze alloy. The braze region (32) will have a forward braze region extremity towards (26) and a rearward braze region extremity end towards (27). The axis (31) may conveniently be the axis of the conical form on the inner body (30) which may also serve as the axis of the brazed assembly (25). The axes of the inner and outer bodies will be substantially coincident; i.e., preferably the angle between said axes will be no more than about 5° or no more than 3°. The braze region (32) exists between the conical frustrum recess (29) and the conical frustrum form or more generally, may be a region of overlap between (29) and (30). The assembly (25) is at a low or an ambient temperature, denoted Tₐ. The outer body (28) includes a first material with a thermal expansion coefficient α1 and the inner body (30) includes a second material with a thermal expansion coefficient α2, whereby α2>α1.

The dimensions of the inner body (30) of the brazed assembly (25) at the low or ambient temperature are described by the radii R_{Ca} and R_{Da} and the dimension Li; where the subscript ‘C’ and ‘D’ relate to the points C and D in FIG. 8 and the subscript ‘a’ denotes the low or ambient temperature. The dimensions of the conical recess within the outer body (28) of (25) are the radii R_{Aa} and R_{Ba} and the dimension Lo. The apex angle of the conical recess (29) may be 2.θ or for example, it may be within the range 2.θ+/−2°, in which case, it will be deemed substantially equal to 2.θ. Where Lo is equal to Li, both may be denoted L. R_{Aa} and R_{Da} will be the base radius of the conical recess (Ro) and the base radius of the conical form (Ri) respectively. The inner body (30) has a lower face (33) and the outer body (28) has a lower face (34). Both (33) and (34) lie in a transverse plane of the assembly; a transverse plane being any which is normal to the axis (31). The forward end (26) of each of the inner and outer bodies and the assembly (25) is proximal the apices of (29) and (30). The rearward end (27) is axially opposite the forward end. A radial direction is any direction normal to the axis (31).

In FIG. 8, the interim brazed assembly (35) is at an elevated temperature and includes (30) and (28) as in (25). The braze region (36) in (35) is of a different geometry to the braze region (32) in (25), but (36) will also have a forward braze region extremity towards (26) and a rearward braze region extremity towards (27). The temperature of (35) is greater than the temperature of (25) by an amount ΔT. The dimensions R_{Ae}, R_{Be}, R_{Ce} and R_{De} are defined by the radial displacement of points A, B, C and D due to thermal expansion, as defined in Equations (1) to (4) in which the subscript ‘e’ denotes an elevated temperature.

R_{Ae}=R_{Aa}·(1+α1·ΔT) Eqn. (1)

R_{Be}=R_{Ba}·(1+α1·ΔT) Eqn. (2)

R_{Ce}=R_{Ca}·(1+α2·ΔT) Eqn. (3)

R_{De}=R_{Da}·(1+α2·ΔT) Eqn. (4)

The lower face (34) of the outer body (28) in (35) is provided with an offset (37) in the axial direction relative to lower face (33) of the inner body (30). The magnitude of the offset (37) may be expressed for example by the quantity d₀·(1+α2·ΔT), where d₀ may be a low or ambient temperature dimension. Where d₀ is realised as a physical dimension in an article composed of the second material, the offset (37) at elevated temperature will be d₀·(1+α2·ΔT). Where dₒ is alternatively realised as a physical dimension in any other material with thermal expansion coefficient ax, the offset (37) will be d₀·(1+αx·ΔT).

A braze process will be taken to mean the heating phase in which the assembly temperature is increased to a maximum braze process temperature Tₘₐₓ, which is above the braze liquidus temperature and the subsequent cooling phase in which the assembly temperature is reduced to a low or an ambient temperature. Reference to a “pre-brazed assembly” will be taken to mean an assembly in which the braze alloy has yet to establish a metallurgical bond with the surfaces of the conical recess and the conical form. Reference to an “interim brazed assembly” will mean the brazed assembly at any point after which a metallurgical bond has been established and the mean braze assembly temperature is within the temperature interval ΔT.

Thermal expansion of the inner and outer bodies in (35) also results in a relative axial displacement of point C relative to point D and B relative to A. The Z coordinates of points A, B and C at elevated temperature (Z_{Ae}, Z_{Be} and Z_{Ce}) are given by Equations (5) to (7). Where Lo is not equal to Li, care will be taken to substitute the relevant parameter in place of L below.

Z_{Ae}=Z_{De}+d₀·(1+α2·ΔT) Eqn. (5)

Z_{Be}=Z_{De}+d₀·(1+α2·ΔT)+L·(1+α1·ΔT) Eqn. (6)

Z_{Ce}=Z_{Ce}+L·(1+α2·ΔT) Eqn. (7)

In accordance with embodiments of the present disclosure where the thermal expansion coefficient of the inner body α2 is greater than the thermal expansion coefficient of the outer body α1: during the cooling stage of a braze process, at an elevated temperature equal to or below the braze solidus temperature, T_{Sol}, the lower face (33) of the inner body (30) is at an axial position defined by the offset (37), relative to the lower face (34) of the outer body (28), while during the period in which the interim brazed assembly cools to a low or an ambient temperature through a temperature interval ΔT, the axial distance between face (33) and face (34) is progressively reduced substantially in proportion to the instantaneous temperature of the assembly. The cumulative axial displacement at the lowest temperature in the interval ΔT is d₀. The magnitude of d₀, which defines the offset (37) ensures that the volume of the braze region at the low or ambient temperature (32) is less than the volume of the braze region at the elevated temperature (36) by an amount substantially equal to the change in the volume of the braze alloy due to the temperature interval ΔT. Where V_{ga} represents the volume of (32), as defined by a rotation about the axis (31) of the quadrilateral formed by Aₐ, Bₐ, Cₐ and Dₐ; and where V_{ge} represents the volume of (36), as defined by a rotation about the axis (31) of the quadrilateral formed by Aₑ, Bₑ, Cₑ and Dₑ; d₀ is such that V_{ga} is related to V_{ge} substantially in accordance with Eqn. (8).

V_{ga}=V_{ge}/(1+3·ΔT·αb) Eqn. (8)

The term (3·ΔT·αb) represents the change in the volume of the braze alloy due to the temperature interval ΔT. Absent the offset (37) at the elevated temperature and the subsequent progressive axial displacement of the inner body relative to the outer body as the interim brazed assembly is cooled, the braze region between the conical form of (30) and the conical recess (29) expands and the braze alloy contracts. Both contribute to the formation of residual stresses within the assembly (25). The closer to adherence to Equation (8), the lower the resulting residual stress.

Equations (9) to (18) give the volume of the braze region (32) V_{ga} and the volume of the braze region (36) V_{ge}. It is defined that x=+1 where the outer body has a lower expansion coefficient relative to that of the inner body. Combining Equations (9)-(18) and (1)-(8) provides a means of determining d₀. Equations (5) and (6) will use the relevant expansion coefficient for the material in which d₀ is physically realised.

$$\begin{matrix}{V}_{ga} = χ \cdot ( {V}_{ABa} - {V}_{CDa} + {V}_{BCa} + {V}_{ADa} ) & Eqn . ( 9 ) \\ {V}_{ge} = χ \cdot ( {V}_{ABe} - {V}_{CDe} + {V}_{BCe} + {V}_{ADe} ) & Eqn . ( 10 ) \\ {V}_{ABa} = \frac{π}{3} \cdot ( {Z}_{Ba} - {Z}_{Aa} ) . ( {R}_{Aa}^{2} + {R}_{Ba}^{2} + {R}_{Ba} . {R}_{Aa} ) & Eqn . ( 11 ) \\ {V}_{CDa} = \frac{π}{3} \cdot ( {Z}_{Ca} - {Z}_{Da} ) . ( {R}_{Ca}^{2} + {R}_{Da}^{2} + {R}_{Ca} . {R}_{Da} ) & Eqn . ( 12 ) \\ {V}_{BCa} = \frac{π}{3} \cdot ( {Z}_{Ca} - {Z}_{Ba} ) . ( {R}_{Ba}^{2} + {R}_{Ca}^{2} + {R}_{Ba} . {R}_{Ca} ) & Eqn . ( 13 ) \\ {V}_{ADa} = \frac{π}{3} \cdot ( {Z}_{Aa} - {Z}_{Da} ) . ( {R}_{Aa}^{2} + {R}_{Da}^{2} + {R}_{Aa} . {R}_{Da} ) & Eqn . ( 14 ) \\ {V}_{ABe} = \frac{π}{3} \cdot ( {Z}_{Be} - {Z}_{Ae} ) . ( {R}_{Ae}^{2} + {R}_{Be}^{2} + {R}_{Be} . {R}_{Ae} ) & Eqn . ( 15 ) \\ {V}_{CDe} = \frac{π}{3} \cdot ( {Z}_{Ce} - {Z}_{De} ) . ( {R}_{Ce}^{2} + {R}_{De}^{2} + {R}_{Ce} . {R}_{De} ) & Eqn . ( 16 ) \\ {V}_{BCe} = \frac{π}{3} \cdot ( {Z}_{Ce} - {Z}_{Be} ) . ( {R}_{Be}^{2} + {R}_{Ce}^{2} + {R}_{Be} . {R}_{Ce} ) & Eqn . ( 17 ) \\ {V}_{ADe} = \frac{π}{3} \cdot ( {Z}_{Ae} - {Z}_{De} ) . ( {R}_{Ae}^{2} + {R}_{De}^{2} + {R}_{Ae} . {R}_{De} ) & Eqn . ( 18 )\end{matrix}$$

Equation (19) and Conditions (1) and (2) provides an approximate relationship between the parameter d₀ and the parameters Rot, Rit, g, αi, αo, αb and ΔT, which is sufficiently accurate (>95%) for embodiments in accordance with the present disclosure. The Conditions (1) and (2) relating to Ri, Ro and g in Equation (19) determine radii Rit and Rot which lie in the same transverse plane of the assembly and which are derived from, or which may be equal to Ro and Ri. In (25) for example, Rot=Ro=R_{Aa} and Rit=Ri=R_{Da}. The parameters αi and αo are the expansion coefficients of the inner and outer bodies respectively; in (25), αi=α2 and αo=α1. As the term (1+αx·ΔT) will typically be within about 1% of unity, it may generally be neglected.

$${d}_{0} = \frac{\begin{matrix}( ( \frac{g . ( Rit + Rot ) . \sqrt{1 + \frac{1}{{tan}^{2} θ}}}{\begin{matrix}( Rit + Rot + Δ T . ( Rit . α i + \\ Rit . α o ) ) . ( 1 + \frac{Δ T . ( α o + α i )}{2} )\end{matrix}} ) - \\ \frac{Rot . ( 1 + α o . Δ T )}{tan θ} + \frac{Rit . ( 1 + α i . Δ T )}{tan θ} )\end{matrix}}{( 1 + α x . Δ T )} \qquad Eqn . ( 19 )$$

Whereby if Ro>Ri+g/cos θ,Rot=Ri+g/cos θ,Rit=Ri,or Condition (1)

Whereby if Ri>Ro−g/cos θ,Rit=Ro−g/cos θ,Rot=Ro Condition (2)

Equation (19) provides a positive d₀ value where αo is less than αi and provides a negative d₀ value where αo is greater than αi. For a positive dₒ value, the direction of axial displacement during cooling of the interim braze assembly is such that the rearward end of the inner body is made more proximal the forward end of the outer body. For a negative dₒ value, the direction of axial displacement is such that the rearward end of the inner body is made more distal the forward end of the outer body.

The axial displacement of the inner body relative to the outer body, as the interim brazed assembly cools by an amount ΔT, is externally effected and results in substantially plastic shear deformation of the braze layer. With reference to FIG. 9, the plastic shear strain γ within the braze layer, as it is deformed through the angle λ may be approximated by Equation (20).

γ=d₀/(g·cos(θ)) Eqn. (20)

Depending on the characteristics of the braze alloy employed, brazed joints in accordance with the present disclosure may be such that the accumulated plastic shear strain within the braze layer does not substantially exceed four or even three, as excessive deformation may cause void formation. Where for example the braze alloy exhibits limited ductility within the temperature range of interest, the accumulated plastic shear strain may not substantially exceed for example two or even one. Plastic deformation of the braze alloy is advantageous also in terms of work-hardening the braze alloy and thereby increasing braze joint strength.

The relative axial displacement of the inner and outer bodies may for example, be effected by hydraulic or electro-mechanical activated tooling dies within a press frame. The instantaneous relative displacement of the inner and outer bodies, as measured for example between face (33) and face (34), may be determined using a digital indicator probe, interferometer or any other precision measuring method which may be adequately thermally insulated. The relative axial displacement of the inner and outer bodies may be expressed in terms of positions on (28) and (30) other than the relative positions of (33) and (34). The process of effecting the axial displacement of the inner body relative to the outer body may be controlled in proportion to a temperature or temperatures at one or more locations on said assembly which may be indicative of its mean temperature. Temperatures of said assembly may be determined using an infrared temperature sensor or a thermocouple for example. In some embodiments, control may be effected on the basis of applied load or on both the basis of applied load and cumulative displacement. Control algorithms may compensate against thermal gradients and thermal expansion or contraction of any or all elements within the process; and may also compensate for elastic or other deformations including those relating to contact stiffness. A further benefit of the present disclosure is that the force required to effect the relative axial displacement of the inner and outer bodies serves to provide in-process validation or proof-testing of the brazed assembly.

The thickness g of the braze region (32) may be limited to values between about 0.025 mm to about 0.35 mm for example, or it may be limited to values substantially between 0.075 mm and 0.25 mm for example. Where the braze region thickness is inadequate, the flow of flux and or braze may be restricted such that cleaning and braze-wetting of the entire area of the joint may be compromised. Where the braze region thickness is excessive, the capillary forces which serve to draw and distribute the braze into the braze region may be reduced, resulting in inadequate coverage. Embodiments of the present disclosure may include a single braze alloy or may incorporate within the braze region a ‘tri-foil’ or ‘sandwich’ braze product. In the later embodiments, the dimension g may be multiples of for example 0.25 mm or 0.35 mm.

The temperature interval ΔT may be determined for example by both the solidus temperature of the braze alloy, T_{Sol} and ambient temperature, Tₐ. The ambient temperature may for example be about 20° C. or it may be a temperature at which the brazed assembly will operate in service which may be more than or less than about 20° C. In the case of embodiments in which, as an alternative to the use of a braze alloy, bonding is effected by diffusion bonding across a third material within the bond region which remains substantially solid throughout said bonding process, ΔT may be determined for example by the maximum process temperature, Tₘₐₓ, and an ambient temperature. Where for example, because of practical considerations, it not convenient to realise the entire axial displacement d₀ over the entirety of the temperature interval ΔT, one may effect a reduced axial displacement d₀_{_}_{EFF} over a reduced temperature interval ΔT_{EFF} or over the temperature interval ΔT. Said considerations may include for example very high strength developing in braze or bonding alloys at temperatures approaching ambient, or any period of cooling prior to the application of the forces required to effect the relative axial displacement. ΔT_{EFF} may be defined by a start temperature T_{S} and an end temperature T_{E} such that ΔT_{EFF}=T_{S}−T_{E}. Where bonding is effected through melting and solidification of a braze alloy, T_{S} may be less than the braze alloy solidus temperature. Where bonding is effected through diffusion bonding of a bonding material within the bonding region which remains solid during the bonding process, T_{S} may be less than the bonding process maximum temperature Tₘₐₓ. T_{E} may be an ambient temperature or it may be higher than an ambient temperature, but will be less than T_{S}.

The ratio of d₀_{_}_{EFF} to d₀, which may be proportional to the ratio of ΔT_{EFF} to ΔT, will influence the magnitude of the reduction in residual stresses and if insufficient, decohesion of the braze or bonding layer and or cracking within the assembly. Where for example, d₀_{_}_{EFF} d₀ is close to unity, the volume of the braze region at the low or ambient temperature (32) will be less than the volume of the braze region at elevated temperature (36) by an amount about equal to the change in the volume of the braze alloy due to the temperature interval ΔT (as per Equation (8)) and residual stresses will be minimal. The preferred ratio of d₀_{_}_{EFF} to d₀ will depend at least on the properties of the materials within the bonded assembly and the anticipated conditions of use, of which there are many. Where for example, the thermal expansion coefficients of the inner and outer bodies differ by more than a factor of about two, it is preferable that d₀_{_}_{EFF} will be at least about 30% of d₀, or more preferably, d₀_{_}_{EFF} will be at least about 50% of d₀. Where for example, the thermal expansion coefficients of the inner and outer bodies differ by more than a factor of about three, it is preferable that d₀_{_}_{EFF} will be at least about 50% of dₒ, or more preferably, d₀_{_}_{EFF} will be at least about 70% of d₀. Where for example, the thermal expansion coefficients of the inner and outer bodies differ by about 50%, it is preferable that d₀_{_}_{EFF} will be at least about 20% of d₀. It is preferable also that d₀_{_}_{EFF} be limited in relation to the term d₀·(ΔT_{EFF}/ΔT). Preferably, d₀_{_}_{EFF} will be less than about twice the value of d₀·(ΔT_{EFF}/ΔT) so as not to subject the outer body to excessive hoop stresses. More preferably, d₀_{_}_{EFF} may be no greater than about 1.3 times d₀·(ΔT_{EFF}/ΔT). Most preferably, d₀_{_}_{EFF} will be no greater than about 1.1 times d₀·(ΔT_{EFF}/ΔT).

Where d₀_{_}_{EFF} is less than d₀, the resultant braze region thickness g_{R}, in the brazed assembly may be greater than the value g employed in design of the brazed assembly. Where d₀_{_}_{EFF} is about d₀, the braze region thickness in the bonded assembly will be about the value g. Where d₀_{_}_{EFF} is significantly less than d₀, the resultant thickness of the braze region (32) in the bonded assembly will be g_{R}≈(g+(|d₀−d₀_{_}_{EFF}|)·sin(θ)). It will be noted that while geometrical relationships provided throughout this disclosure may be considered approximations in that they do not incorporate elastic deformations which may arise—they are entirely adequate for realising embodiments with significantly lower residual stresses relative to the prior art.

A further benefit of the present disclosure is that it provides a means of optimising the residual stresses within a brazed assembly in relation to the anticipated service temperature or temperature range. For example, where a service temperature of 200° C. is anticipated for brazed assemblies in accordance with the present disclosure; embodiments characterised by a ΔT extending from the braze alloy solidus to about 200° C. may have lower residual stress in service relative to embodiments for which ΔT extends from the braze alloy solidus to about 20° C.

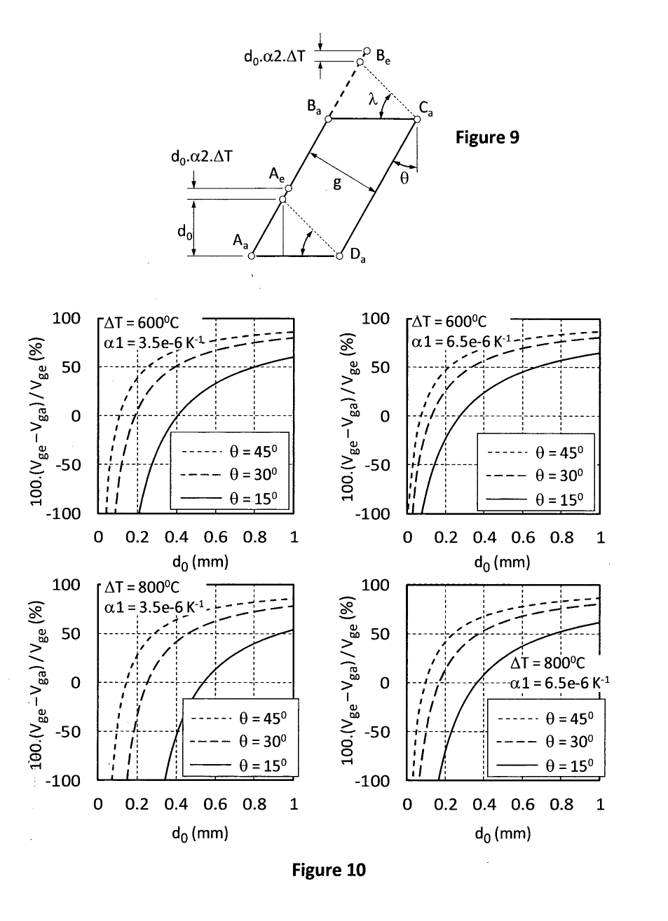

FIG. 10 illustrates the percentage change in the volume of braze regions such as (32) and (36) over a temperature interval ΔT as a function of the parameter d₀—said change defined as 100·(V_{ge}−V_{ga})/V_{ge}. The dimensions L, g and R_{Aa} are 10 mm, 0.1 mm and 20 mm respectively. The thermal expansion coefficient for the inner body (α2) in all cases is 12.5e-6 K⁻¹. For each geometry and combination of α1 and α2, there is a unique value of d₀ which provides for a constant braze region volume within the temperature interval ΔT. For example, in the lower right chart where ΔT=800° C., the d₀ value is about 0.36 mm where θ=15°.

FIG. 11 provides examples of embodiments of the present disclosure. FIGS. 11A and 11B shows d₀ and the corresponding braze region shear strain as a function of the apex half-angle θ, for brazed assemblies with different combinations of α1 and α2 and with the following characteristics: g=0.1 mm, L=10 mm, R_{Aa}=20 mm, αb=20e-6 K⁻¹ and ΔT=650° C. FIGS. 11C and 11D show the d₀ values and corresponding shear strain in which the influence of braze region thickness g is demonstrated; these embodiments have α1=6.5e-6 K⁻¹ and α2=12.5e-6 K⁻¹ and otherwise have the same characteristics as noted in relation to FIG. 11A.

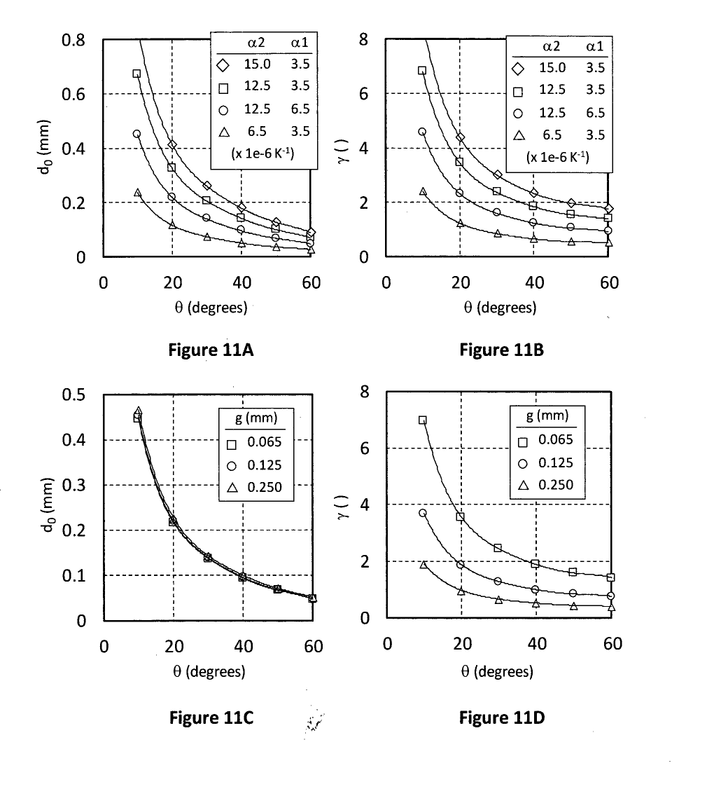

Embodiments of the present disclosure include brazed assemblies where an inner body has a expansion coefficient α1 which is lower than the expansion coefficient α2 of an outer body. In FIG. 12, an interim brazed assembly (38) with a forward end (26) and a rearward end (27) at an elevated temperature includes, an outer body (28) including a conical recess (29) and an inner body (30) including a conical form, both bodies being substantially rotationally symmetric about the axis (31), which may also be the axis of (29) and or (38). Bodies (30) and (28) are separated by a braze region (36) which includes a braze alloy; said braze alloy metallurgically bonded to the conical recess (29) and to the conical form of the inner body. In (38), (30) has a lower face (33) which is aligned in the axial direction with the lower face (34) of (28)—that is to say, both radii R_{Ae} and R_{De} are substantially within the same transverse plane of (38). The points Aₑ, Bₑ, Cₑ and Dₑ define (36) at the elevated temperature. Note that for consistency, the points A and B are located on the body including the material of the lower expansion coefficient α1, and C and D, on the body including the material of the higher expansion coefficient α2. Therefore, R_{Aa} and R_{Da} will be the base radius of the conical form (Ri) and the base radius of the conical recess (Ro) respectively. The brazed assembly (39) in FIG. 12 is at a low or an ambient temperature which is lower than the elevated temperature of (38) by an amount ΔT. The brazed assembly (39) includes (30), (28) and a braze region (32) which is of a different geometry to (36) in (38). The lower face (33) of (30) in (39) is at an axial position (40) relative to the lower face (34) of (28). The axial position (40) is defined by an offset parameter d₀. The radial positions of A, B, C and D in FIG. 12 at the elevated temperature and the low or ambient-temperature are given by Equations (1) to (4). The relative axial positions of A, B, C and D are given by Equations (21) to (23), where solely for convenience, Z_{De}=Z_{Ae}, Lo=Li=L and where the subscripts ‘e’ and ‘a’ denote the elevated and low or ambient temperature respectively.

Z_{Da}=Z_{Aa}+d₀ Eqn. (21)

Z_{Ca}=Z_{Ba}+d₀ Eqn. (22)

Z_{Ce}=Z_{Be}+L·ΔT(α2−α1) Eqn. (23)

In accordance with embodiments of the present disclosure where the expansion coefficient of the inner body α1 is lower than the expansion coefficient of the outer body α2; as an interim braze assembly cools through a temperature interval ΔT, the axial distance between face (33) and face (34) is progressively increased substantially in proportion to the instantaneous temperature of the assembly, such that the ultimate displacement during the interval ΔT is d₀. The magnitude of d₀, ensures that the volume of the braze region at the low or ambient temperature (32) is less than the volume of the braze region at the elevated temperature (36) by an amount substantially equal to the change in the volume of the braze alloy over the temperature interval ΔT in accordance with Eqn. (8). For a given combination of the parameters R_{Aa}, R_{Ba}, L, g, α1, αb, α2 and ΔT, d₀ may be determined from Equations (1)-(4), (8)-(18) and (21)-(23), where by definition, because the outer body has a higher expansion coefficient relative to that of the inner body, χ=−1. For Equation (19), αi will be α1, αo will be α2 and d₀ will be (by definition) a negative value.

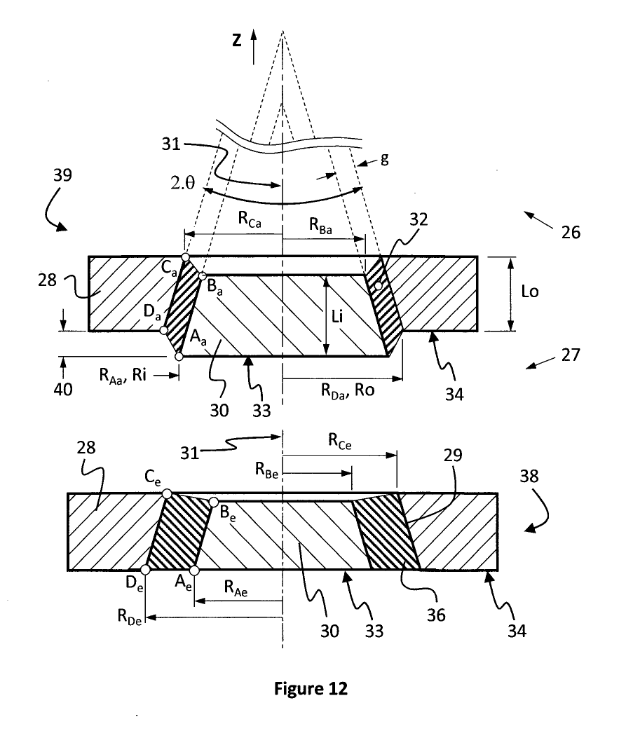

FIG. 13 shows examples of embodiments in accordance with the present disclosure where the expansion coefficient of the inner body is lower than that of the outer body. FIGS. 13A and 13B show the d₀ and shear strain (γ) values respectively, as a function of the cone apex half-angle θ; where α1=6.5e-6 K⁻¹ and α2=12.5e-6 K⁻¹, g=0.1 mm and ΔT=650° C. FIGS. 13C and 13D shows the d₀ and shear strain (γ) values respectively, as a function of the cone apex half-angle θ; where α1=3.5e-6 K⁻¹ and α2=8.6e-6 K⁻¹, g=0.1 mm and ΔT=650° C. With regard to the embodiments disclosed in FIGS. 11 and 13, it will be evident that excessively large plastic shear strain may be avoided through the use of larger cone apex angles and or lower ΔT values. Alternatively, excessively large shear strains may be avoided with larger braze region thicknesses including for example, incorporation of material within the braze region which remains solid throughout the entire braze process. Larger cone apex angles may be advantageous for example in embodiments which are relatively large in size, or in embodiments requiring a large ΔT.

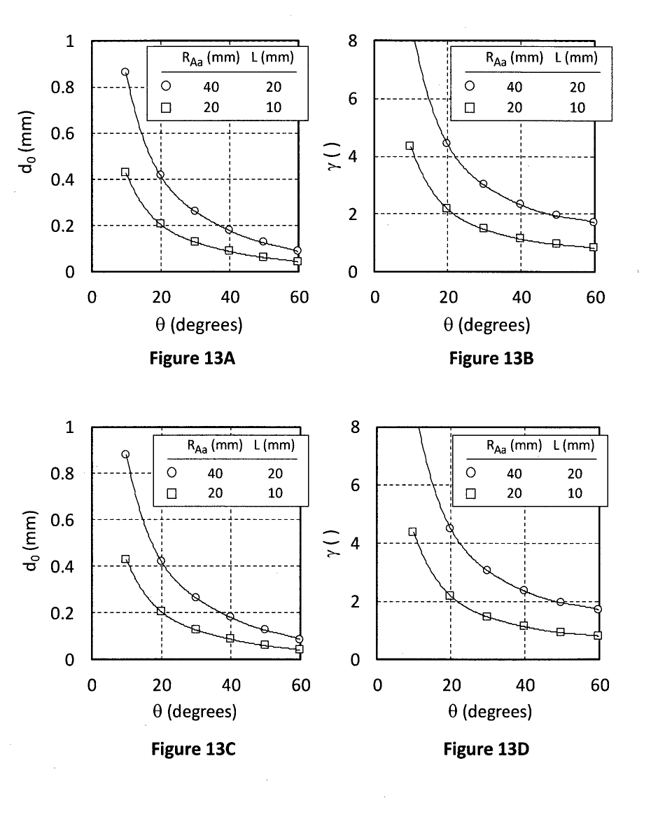

Embodiments of the present disclosure may include bodies which exhibit non-uniform thermal expansion; for example, where either the inner body or the outer body of the brazed assembly comprises a laminate structure including PCD. PCD has a high stiffness and a low coefficient of thermal expansion relative to the cemented carbide support layer, which is included in the majority of commercial materials. Thermal expansion and contraction of the laminate structure may be non-uniform and or anisotropic. FIG. 14A shows in cross-section a portion of an outer body (41) which is a component of an embodiment of the present disclosure. Body (41) is rotationally symmetric about the axis (31) and has a conical frustrum recess (29) defined by the dimensions R_{Ba}, R_{Aa} and L. The outer body (41) comprises a PCD layer (42) of thickness L₃ which is integrally bonded to a cemented carbide layer (43) including a conical frustrum recess (29). The outer body (41) in FIG. 14A may be taken to be at a low temperature or an ambient temperature. In accordance the present disclosure, (41) may be assembled with at least an inner body and a braze alloy so as to form a pre-braze assembly. The pre-braze assembly may be heated above the braze alloy liquidus temperature. The present disclosure includes bonded assemblies in which a bonding material disposed in a bonding region remains solid during the bonding process.

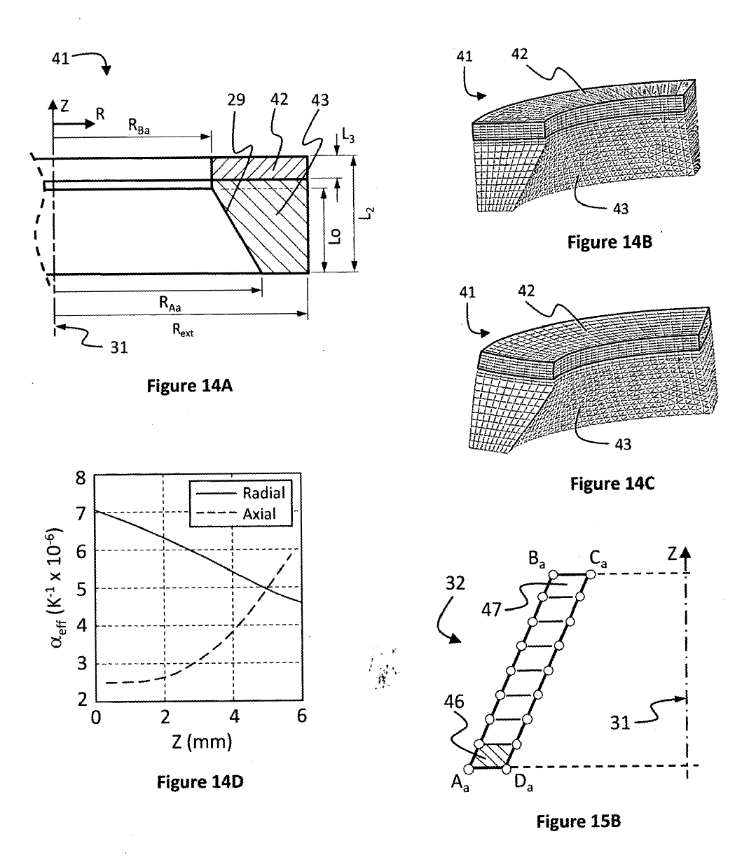

FIGS. 14B and 14C depict one quadrant of rotationally symmetrical models of (41) at room temperature and 750° C. respectively which illustrate the mode of thermal deformation. R_{Aa}=14.72 mm, R_{Ba}=11.26 mm, Rₑₓₜ=18.0 mm, Lo=6.0 mm, L₂=8.0 mm and L₃=1.5 mm. In 14C, (42) has exhibits a degree of curvature in the radial direction (defined by ‘R’ in FIG. 14A) due to the greater expansion of the cemented carbide layer (43) relative to the PCD layer. Both components of (41) therefore exhibit non-uniform expansion, a behaviour which may be considered in the design of braze joints in accordance with the present disclosure. FIG. 14D provides the effective thermal expansion coefficients, α_{eff}, in the radial and axial directions at different axial positions along the conical frustrum (29) of (41); the greater the Z coordinate value, the more proximal the PCD layer. The outer body (41) may be assembled with an inner body (30) to form the assembly (44) in FIG. 15A at a low or ambient temperature, in which the braze region (32) has a volume V_{ga}. Braze assembly (45) is at an elevated temperature and incorporates (30), (41), (36) and the offset (37) between faces (34) and (33). In accordance with the present disclosure; where the inner body and or the outer body of a brazed assembly exhibits anisotropic and or non-uniform thermal expansion, the parameter d₀ or d₀_{_}_{EFF} may be determined so as to substantially minimise the quantity ΔV_{g} as is defined in Equation (24).

ΔV_{g}=V_{ga}−V_{ge}/(1+3·ΔT·αb) Eqn. (24)

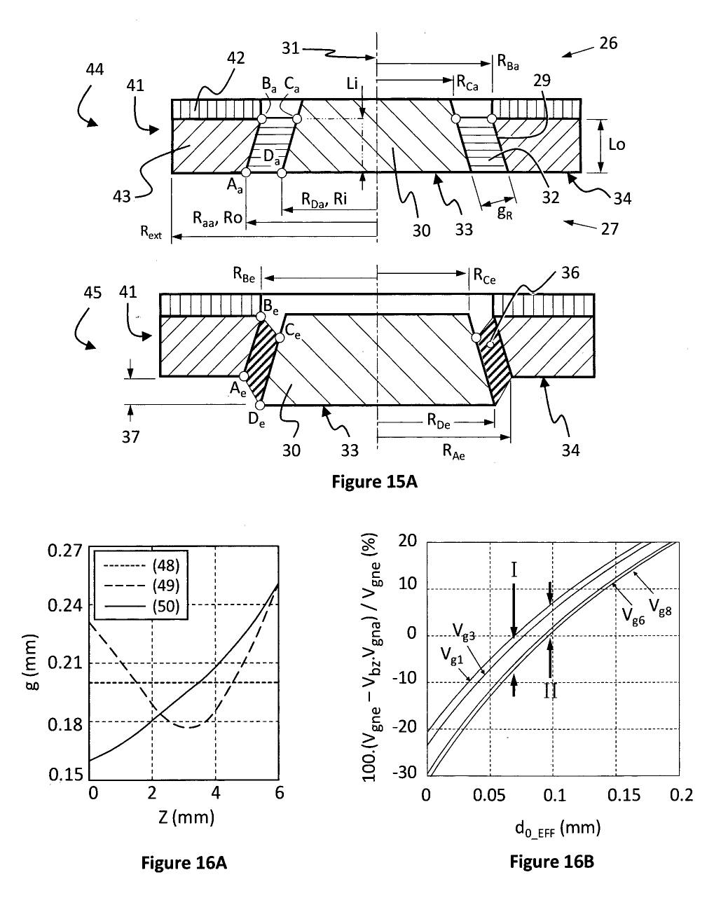

FIG. 16A shows three different braze region thickness profiles which may be employed in the design of brazed assemblies such as (44); where in this example R_{Aa}=14.72 mm, R_{Ba}=11.26 mm, Rₑₓₜ=18.0 mm, Lo=6.0 mm, L₂=8.0 mm, L₃=1.5 mm, θ=30° and where the temperature interval ΔT_{EFF} is 450° C. The braze region thickness is expressed as a function of the Z position on the conical frustrum. The profile (48) in FIG. 16A is a uniform braze region thickness of 0.2 mm. The profiles marked (49) and (50) represent braze regions of non-uniform thickness. As the temperature interval ΔT_{EFF} is employed (where ΔT_{EFF}≤ΔT), the braze region thickness in the final braze assembly will be g_{R} where g_{R}≥g. Considering discrete elements of braze regions (32, 36): braze region element (46) of (32) in FIG. 15B is the lower or more rearward element and has a volume at a low or ambient temperature of V_{g1a} and at an elevated temperature, V_{g1e}.

Element (47) is the uppermost or most forward braze region element and has a volume at a low or ambient temperature of V_{g8a} and at an elevated temperature, V_{g8e}. The n^{th} braze region element volume at a low or ambient temperature will be denoted V_{gna}, and at an elevated temperature, V_{gne}. FIG. 16B shows the percentage variation between the low or ambient temperature braze region element volumes, V_{gna} and the corresponding elevated temperature braze region element volumes, V_{gne} as a function of d₀_{_}_{EFF} for the braze region thickness profile (58). The data pertains to a brazed assembly where the inner body (30) has an expansion coefficient of 12.5e-6 K⁻¹, αb=19e-6 K⁻¹ and (41) has the characteristics in FIG. 14D. For clarity, the percentage variation in the braze region element volumes is shown only for four of the eight braze region elements and is defined as: 100·(V_{gne}−(1+3·αb·ΔT)·V_{gna})/V_{gne}. Where d₀_{_}_{EFF}=0, the variation in the volume of braze region element 1 (46) is −20% and for element 8 (47), it is −31%. It will be evident that there is no single value of d₀_{_}_{EFF} which ensures volumetric consistency for each braze region element. Where d₀_{_}_{EFF}≈0.069 mm, the volume of the braze region element 1 is consistent within the interval ΔT_{EFF}, however, for the same value of d₀_{_}_{EFF}, the variation for braze region element 8 is −7%. Where d₀_{_}_{EFF}=0.097 mm, V_{g8} is consistent, however, the variation in V_{g1} is +6%. These two cases are denoted by the pairs of arrows marked I and II.

The most appropriate d₀ or d₀_{_}_{EFF} value to employ for embodiments of the present disclosure in which an outer body and or an inner body exhibits non-uniform and or anisotropic thermal expansion, may be dependent on the location of the most critical region of the brazed assembly, as may be dictated by in-service loading conditions. Alternatively, it may be desirable to minimise the total residual strain energy within the brazed assembly whereby one may adopt for example the d₀_{_}_{EFF} value at which the volume-weighted mean of the percentage variation values for the braze region elements comprising the braze joint is minimal. The d₀_{_}_{EFF} value thereby determined for FIG. 16B is 0.083 mm. If for example for (44) and (45), ΔT=650° C. and g=0.2 mm, g_{R} will be about 0.218 mm; as dₒ is about (650° C./450° C.)·dₒ_{_}_{EFF} and as g_{R}≈(g+(d₀−d₀_{_}_{EFF})·sin θ.

That it may be convenient to have faces (33) and (34) co-planar either at an elevated temperature as in (38), or co-planar at a low or ambient temperature as in (25), is not a necessity in realising embodiments in accordance with the present disclosure. Embodiments in accordance with the present disclosure may also include assemblies where at least part of the surface area of the conical recess of the outer body apposes at least part of the surface area of the conical frustrum of the inner body; more generally, the forward end of the conical form will be forward the rearward end of the conical recess and the forward end of the conical recess will be forward the rearward end of the conical form body. Conditions (1) and (2) permit the d₀ value to be determined by Equation (19) for all such assemblies. Additionally, only a part of the braze alloy may be disposed within the braze region; the remaining portion of the braze alloy forming for example, fillets external to the braze region (32). The present invention is not limited to cones or conical frustrum, but includes bodies and recesses including substantially conical and or conical frustrum features.

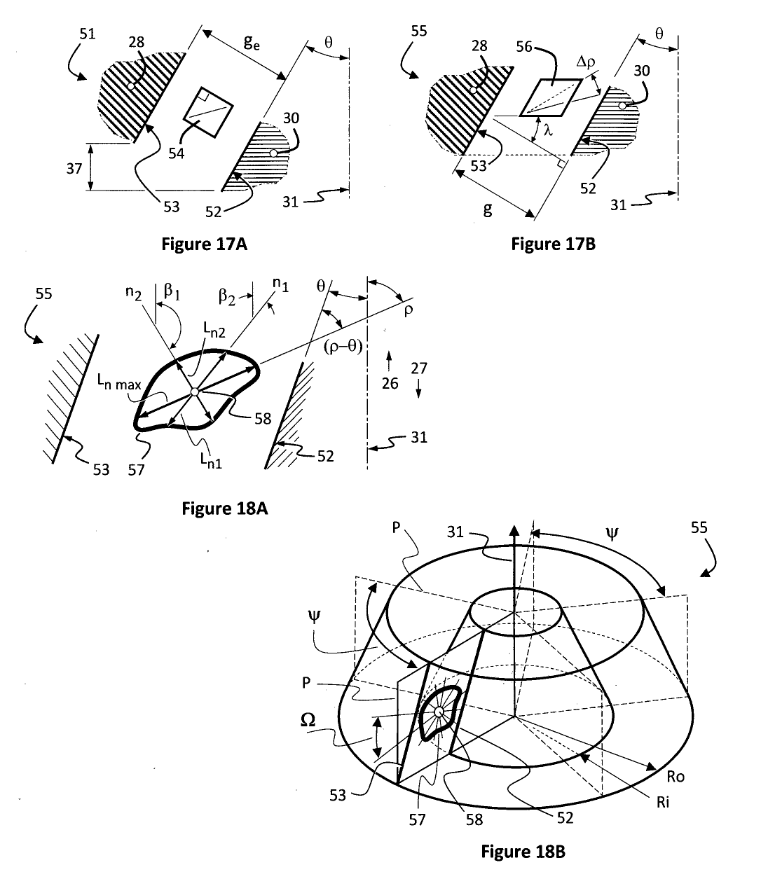

Plastic shear deformation of the braze layer (36) of an interim brazed assembly (35, 38, 45) causes a reorientation of grains therein relative to the axis (31). In FIG. 17A, a region of an interim brazed assembly at an elevated temperature (51) is shown in cross section; an inner body (30) of conical form substantially concentric with an outer body (28) with a conical recess form a braze region of width gₑ, whereby (28) is at an axial position (37) relative to (30). The cross section is in a radial plane P of the brazed assembly (51); said radial plane containing the axis (31) and therefore also containing a generatrix of the conical form (52) and a generatrix of the conical recess (53). The element of braze (54) is parallel to (52) and (53). Upon cooling to an ambient or a low temperature simultaneously with a progressive reduction in dimension (37), (51) will become (55) in FIG. 17B, wherein the element of braze (54) is substantially plastically sheared through the angle λ to form the parallelogram element of braze (56). The plastic shear strain γ (where γ=Tan (λ)), causes a reorientation Δρ, and an elongation of the grains constituting the braze alloy. Note, Δρ is not linearly related to γ, it being dependent also on grain morphology as will be presently demonstrated. In relation to (52) and (53): It will be understood that where the axis of the conical form and the axis of the conical recess are not exactly parallel but misaligned by no more than about 3° to 5° (i.e., substantially parallel), a curve defined by the intersection of a radial plane with the conical recess will adequately approximate a generatrix of the conical recess for the purposes of the present disclosure. It will also be understood that disclosure relating to a ‘generatrix’ may equally apply to any member of the set of all generatrices which comprise a cone and which differ only in their angular position about the axis (31).

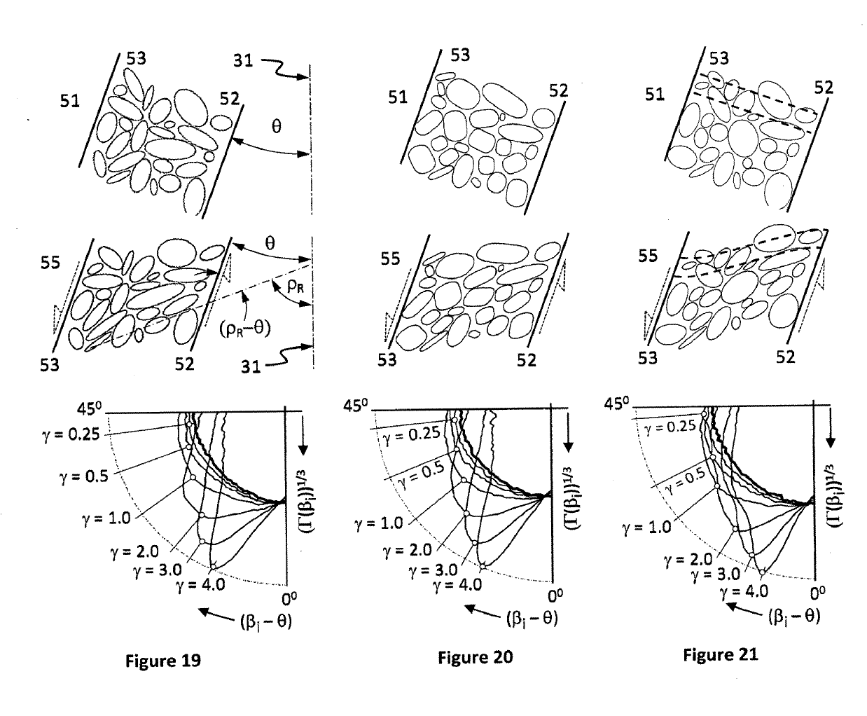

The extent of plastic shear deformation of the braze layer may be estimated using stereological methods on optical or electron micrographs of cross-sections of the braze joint taken in radial planes P of the brazed assembly, said radial planes defined by the generatrices (52) and (53) and the axis (31). Metallurgical preparation may include etching to reveal and or enhance the braze region grain structure which may be analysed using image analysis software. With reference to FIG. 18A, a sectioned grain (57) within the braze region at an ambient temperature lies between the generatrices (52) and (53) where the intercept area A for that grain is determined by its intersection with the radial plane (the radial plane in FIG. 18A being the plane of the page). The intercept area for the sectioned grain (57) has a centroid (58). The alignment of the sectioned grain (57) may be determined by digitally overlaying an isotropic arrangement of 180 lines, each of which extends through (58) and which intercepts the area A over at least one defined length.

With reference to the isometric view of a brazed assembly in FIG. 18B and in the context of characterising braze layer microstructures, the term ‘isotropic’ will generally mean the basis of sampling and analysis which does not introduce bias into the measurement. In relation to intercept lines, it will mean isotropic within the radial plane P of interest, i.e., the angular spacing Ω will be uniform such that for said 180 lines, Ω=1° (for clarity in FIG. 18B, only six uniformly spaced lines are shown). Two such intercept lines are shown also in FIG. 18A as n₁ and n₂; these are orientated relative to (31) at angles β₁ and β₂ and have intercept lengths Lₙ₁ and Lₙ₂. More generally, for a given grain, the orientation and intercept length for each line may be expressed as βᵢ and L_{n i}, where “i” denotes the line number or conveniently, the orientation of the intercept line in degrees. Where any one of the isotropic arrangement of lines intercepts the grain more than once, the intercept length for that line will be the sum of the individual intercept lengths. The maximum intercept length will denote that grain's orientation ρ, relative to the axis (31); i.e., ρ will be equal to the value of βᵢ for the intersect line corresponding to the maximum intercept length.

Braze layers include numerous grains and characterisation may require for example the inclusion of about 20 grains within at least one radial plane cross section or more preferably within each of three to five radial plane cross sections whereby the radial planes P have uniform angular spacing ψ about the axis (31); that is, the radial planes will be isotropic when viewed in a direction parallel to (31). The number of radial planes employed may be denoted ‘q’ while the number of sectioned grains per radial plane may be denoted ‘m’, both m and q being integers. Accordingly, the median grain alignment relative to the axis (31), ρ_{R}, will be the median of the set comprising each ρ value determined independently for each of the m times q analysed grains, whereby ρ_{R}=0°-180°. (The term ‘median’ has equivalent meaning to the term ‘second quartile’). Alternatively expressed, the median grain alignment relative to the generatrices (52, 53) will be (ρ_{R}−θ). Equivalently, where the intercept length corresponding to each intercept line is L_{n ijk}, where “j” denotes the grain number and “k” denotes the section number and where L_{nN ijk} represents the normalised intercept length as defined by Equation (25), a histogram, Γ(βᵢ) may be determined in accordance with Equation (26) by summing, for each intercept line orientation independently (i.e., for each value of βᵢ), the normalised intercept lengths for the m grains within each of the q radial plane sections. The median grain alignment within the braze region relative to axis (31) ρ_{R}, will be that value of βᵢ at which the maximum value of Γ(βᵢ) occurs.

$$\begin{matrix}{L}_{nN ijk} = \frac{{L}_{n ijk}}{{\sum }_{i = 1}^{180} {L}_{n ijk}} & Eqn . ( 25 ) \\ Γ ( {β}_{i} ) = {\sum }_{j = 1}^{m} {\sum }_{k = 1}^{q} {L}_{nN ijk} & Eqn . ( 26 )\end{matrix}$$

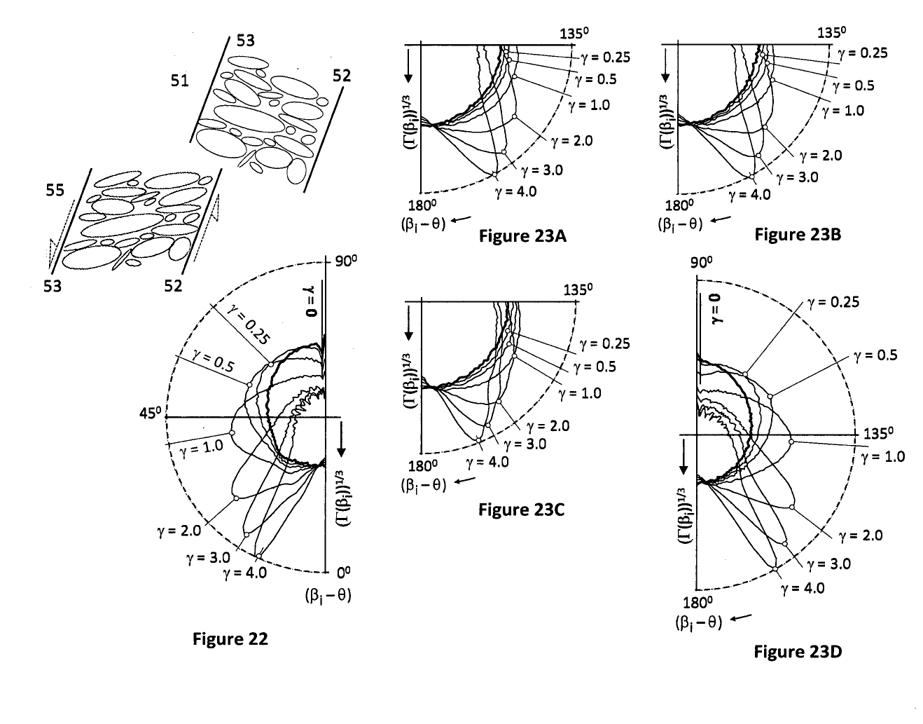

At top of each of FIGS. 19 to 22 is shown the microstructure within a part of a cross section of a braze region within an assembly (51) at an elevated temperature such as T_{S} with an axis (31); (31) shown in FIG. 19 only for conciseness. The expansion coefficient for the inner body with generatrix (52) is greater than that of the outer body with generatrix (53). In (51) in each of FIGS. 19 to 22, 25 sectioned grains (57) are shown which may for example be the primary a-phase copper-rich solid solution which may be substantially surrounded by a eutectic duplex phase matrix. Different embodiments of the present disclosure may, depending for example on the braze alloy composition, have braze region microstructures having several metallurgical phases. The great majority of alloys will by definition contain a primary a-phase which is the first phase to precipitate on solidification of an alloy as may be determined by the alloys phase diagram; said phase diagram relating the phases of various alloy components at various temperatures. Where the primary phase of a braze alloy is of a dendritic structure or where the braze region has only one phase, the methodology herein will equally apply. In embodiments where the braze region includes a metal or a metal alloy which remains solid during the braze process, one may analyse the phase with the greatest volume fraction therein for the purposes of microstructure characterisation. At middle of each of FIGS. 19 to 22 is shown the microstructure within a cross section of a braze layer within an assembly (55) which is at a low or ambient temperature and which has formed from (51) by simultaneous cooling and plastic shear deformation of γ=0.5. The shear direction, indicated by the dashed arrows, is that necessary to substantially ensure volumetric consistency within the braze region given the relationship between the expansion coefficients noted above. Where the inner body has a lower expansion coefficient than the outer body, shear deformation will be in the opposite direction and the grains aligned accordingly. At bottom of each of FIGS. 19 to 22 is a polar chart showing the grain alignment in (55) and for shear deformations of γ=0.25, 1.0, 2.0, 3.0, 4.0 applied to the original microstructure at top. The third root of Γ(βᵢ) is shown against (βᵢ−θ). The third root being merely a means of portraying values varying widely in magnitude. The angular position (βᵢ−θ) of the maximum value of Γ(βᵢ) denotes the median grain alignment arising from the indicated shear strain. In FIG. 19 for example, for 0.25 strain, Γ(βᵢ) is maximal at βᵢ−θ=41°. The bold line in each chart relates to γ=0 and is therefore not in accordance with the present disclosure, but shown by way of reference.

FIG. 19 shows randomly orientated elliptical grains in (51) which in (55) have been subjected to uniform shear deformation. FIG. 20 shows randomly orientated approximately stadium-shaped grains in (51) which in (55) have been subjected to uniform shear deformation. FIG. 21 shows randomly orientated elliptical grains in (51) which in (55) have been subjected to non-uniform shear deformation as portrayed by the change in heavy dashed lines extending between (52) and (53). FIG. 22 shows elongated elliptical grains in (51) exhibiting an initial median alignment approximately normal to (52) and (53). For a shear strain of 0.25 in FIGS. 19 to 21, the grains assume an alignment (ρ_{R}−θ), which is almost 45° to the generatrices (52) and (53). As the extent of shear deformation increases to 4.0, the grains assume an alignment within about 10° of the generatrices (52) and (53). For the example of the anisotropic microstructure in (51) in FIG. 22 in which the grains are initially aligned normal to (52) and (53); a shear deformation of 0.25 realigns the grains by about 20°, such that (ρ_{R}−θ)≈70°. If by way of further example, the initial alignment of grains such as those in FIG. 22 (after solidification and prior to plastic shear deformation), were substantially normal to the axis (31) of the brazed assembly, the quantity (ρ_{R}−θ) for shear strains between 0.25 to 4.0 will be 10° to 38°. More generally, as the extent of shear deformation is increased, (ρ_{R}−θ) decreases—i.e., grain alignment is increasingly parallel to the generatrices. Preferably, embodiments of the present disclosure will have (ρ_{R}−θ) substantially within the range 10° to 70° where the expansion coefficient of the inner body is greater than that of the outer body. It will be noted that λ is not equal to (π/2−(ρ_{R}−θ))—the “π/2” term accounting for the orientation of λ to (52) in FIG. 17B and the orientation of (ρ_{R}−θ) to (52) in FIG. 19. FIGS. 23A to 23D depict the resultant alignment of grains which have the initial structures shown in (51) in each of FIGS. 19 to 22 respectively, but where the coefficient of expansion of the inner body with generatrix (52) is less than that of the outer body with generatrix (53). In such cases, the (ρ_{R}−θ) is substantially within the range 110° to 170°. In the majority of embodiments where the outer body expansion is greater than that of the inner body (e.g., FIGS. 23A-23C), (ρ_{R}−θ) will be between about 135° to 170°.

In addition to the median grain alignment ρ_{R}, embodiments of the present disclosure are characterised in terms of their distribution of alignment values ρ for each of the analysed grains. Where ρ_{R1} and ρ_{R3} represent the first quartile and third quartile respectively of said set comprising each p value determined independently for each of the m times q analysed grains, the quantity (ρ_{R3}−ρ_{R1}) will quantify the distribution. That is, 50% of the grains in a sample of the population of grains within the braze region (32) will have an alignment value in the range (ρ_{R3}−ρ_{R1}). Six grain alignment histograms relating to embodiments of the present disclosure are provided in FIG. 23E for shear strains between 0.25 and 4.0. Each histogram shows the relative number of grains at each grain alignment value (ρ−θ). The vertical offsets between histograms are solely for ease of interpretation. The vertical arrows in each histogram indicate the median grain alignment ρ_{R} for the indicated shear strain. The bold horizontal arrows indicate the quantity (ρ_{R3}−ρ_{R1}). The histogram for γ=0, provided for reference, shows that absent shear deformation, there is no pronounced or significant alignment of grains. Embodiments in accordance with the present disclosure may be seen to have a distribution of grain alignment ρ values less than about 80° and more generally, less than about 70°. It is evident that the distribution of grain alignments ρ, or equally (ρ−θ), reduces with increasing shear strain.

In addition to stereological determination of grain alignment within the braze region—which may be considered to be a morphological characterisation approach—the crystallographic “preferred orientation” of grains included within the braze region may be established by means of X-ray, electron or neutron diffraction. The results of such analyses may be presented a “pole diagram” in which the density of crystal lattice planes and or directions are depicted relative to a defined axis such as axis (31). Grains within the polycrystalline braze region will adopt a so-called “preferred orientation” whereby the preferred slip plane family will align towards the direction of shear. The median orientation of the preferred slip plane family will be substantially parallel to the generatrices (52, 53) lying in the section plane P; for example, the median orientation of the preferred slip plane family may be within +/−40° or less of generatrix (52) or (53), or it may be within +/−35° or less of generatrix (52) or (53). The intensity or degree of coherence of alignment will increase with increasing strain. The median orientation of the preferred slip plane family may be determined in a manner analogous to that employed above for determining the median grain alignment, but whereby crystallographic plane reflection intensity may be employed instead of intercept length. For example, in Ag, Cu and Ag—Cu based brazing alloys, the crystal structure will be face-centered cubic (FCC). Such structures slip primarily on {111} planes. In embodiments of the present disclosure in which the braze alloy has a FCC structure, {111} planes will exhibit a preferred orientation parallel to the generatrices (52, 53).

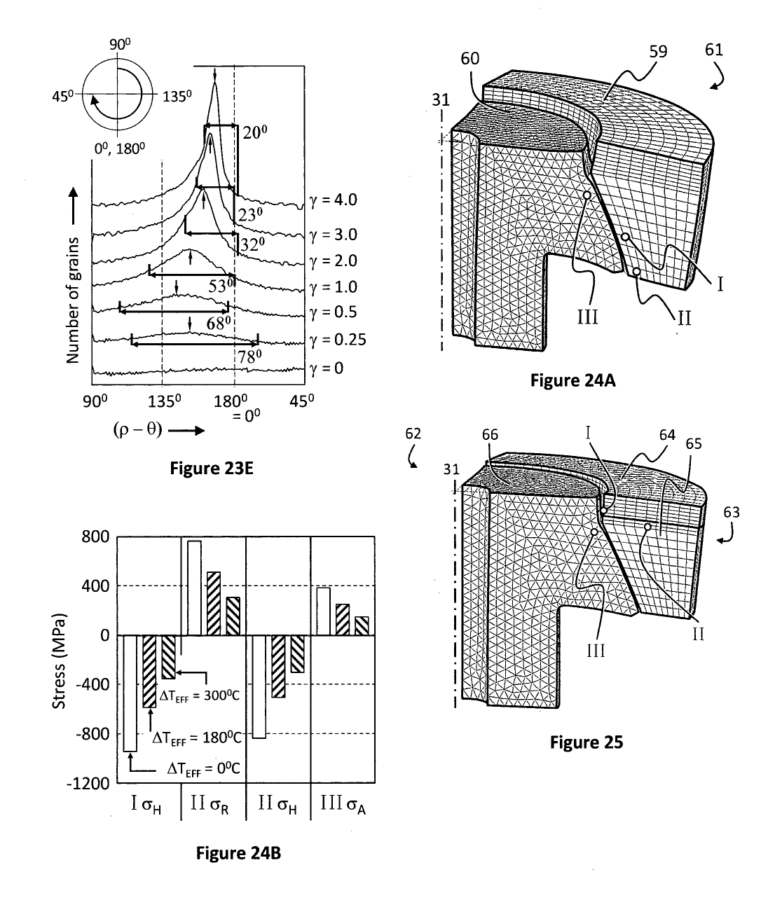

FIG. 24A shows a quadrant of an embodiment in accordance with the present disclosure in which an outer body (59) of silicon nitride is brazed to an inner body of structural steel (60) with axis (31) forming the assembly (61). The braze region is between the conical form of (60) and the conical recess of (59) whereby R_{Aa}=14.72 mm, R_{Ba}=11.26 mm, Rₑₓₜ=18.0 mm, g=0.2 mm, L₂=8.0 mm and L=6.0 mm. The body outline is depicted by greater line width so as to distinguish from the lighter FEA mesh pattern. The deformation of (61) arising from the thermal expansion mismatch between (60) and (59) is exaggerated for the purposes of illustration. The stresses at several locations in (61) are shown in FIG. 24B; each location denoted by a roman numeral. The unhatched bars denote the residual stresses arising in the brazed assembly (61) where ΔT=0° C. (hence, an embodiment not in accordance with the present disclosure). Where in accordance with the present disclosure, ΔT_{EFF} is non-zero, the residual stresses are reduced in relation to the magnitude of ΔT_{EFF}. For ΔT_{EFF}=180° C., the relevant d₀_{_}_{EFF} value is 0.043 mm and where ΔT_{EFF}=300° C., the relevant d₀_{_}_{EFF} value is 0.072 mm. In this example, the present disclosure provides for about 40% reduction in residual stress.

FIG. 25 depicts a quadrant of a brazed assembly (62) in accordance with the present disclosure which includes an outer body (63) including PCD (64) integrally bonded to cemented carbide (65). The conical recess in (65) forms a braze joint with the conical form of (66) which is a structural steel. The dimensions of the components of (62) are L=6.0 mm, L₂=8.0 mm and L₃=1.5 mm and otherwise are the same as those of assembly (61). The deformation of (62) which arises due to a mismatch in the thermal expansion coefficients of the inner and outer bodies is shown amplified for ease of visualisation. Residual stress formation and thermal deformation was modelled using FEA employing the properties in Table 1, the non-linear uniform expansion characteristics for the PCD-carbide laminate depicted in FIG. 14D and by incorporating the inherent stresses in (63) from ultra-high pressure sintering. The hoop stress (σ_{H}) in MPa at position I in the PCD (64) for ΔT_{EFF} values of 200° C. and 300° C. is −580 and −215 respectively. Where ΔT is 0° C. (not in accordance with the present disclosure), the hoop stress at I is −1050 MPa. Absent any braze joint, the PCD-carbide laminate has a hoop stress of almost −400 MPa at position I. The hoop stress (σ_{H}) in MPa, at position II in the carbide (65) for ΔT_{EFF} values of 200° C. and 300° C. is 273 and 477 respectively. Where ΔT is 0° C. (not in accordance with the present disclosure), the hoop stress at II is −23 MPa. The inherent hoop stress at position II is 352 MPa. At position III, the radial stress (σ_{R}) in MPa in the steel body (66) is 129 and −100 respectively for ΔT_{EFF} values of 200° C. and 300° C. Where ΔT is 0° C. and hence not in accordance with the present disclosure, the radial stress at III is +529 MPa—a value which will significantly reduce the bodies fatigue strength. Note, in the case of (62), minimising the volumetric strain within the braze region where ΔT_{EFF}=200° C. and 300° C., the d₀_{_}_{EFF} value is 0.032 mm and 0.048 mm respectively. Experimental results confirm the mode and magnitude of thermal deformations shown in FIGS. 24 and 25. The present disclosure will be understood to advantageously provide a means of moderating and altering the distribution of residual stresses within PCD-carbide laminate structures bonded to materials of higher thermal expansion coefficient. Other examples of brazed assemblies benefiting from improved fatigue strengths include ferrous alloy shafts bonded to ceramic impellers.

FIG. 26 depicts in cross section a brazed assembly (67) in accordance with the present disclosure at an ambient or low temperature, (67) being rotationally symmetric about the axis (31) and including an inner body which is a SCD cutting element (68), an outer body (28) and a braze region of width g_{R} in which a braze alloy is disposed. The outer body is composed of a material with an expansion coefficient 8.0e-6 K⁻¹ and Young's modulus 450 GPa. The SCD cutting element material has an expansion coefficient 3.5e-6 K⁻¹ and Young's modulus 750 GPa. The dimensions characterising (67) are R₁=1.7 mm, L=10 mm, Rₑₓₜ=20 mm, R_{Aa}=10 mm, R_{Ba}=5.33 mm, L₁≈7.8 mm, L₂=3.7 mm and g_{R}=0.2 mm. In accordance with the present disclosure, the inner body is axially progressively displaced relative to the outer body during a cooling interval ΔT_{EFF}, the total displacement being d₀_{_}_{EFF} which is dimension (40) in (67). Where ΔT_{EFF}=200° C. and ΔT_{EFF}=300° C., the axial displacements are d₀_{_}_{EFF}=0.015 mm and d₀_{_}_{EFF}=0.022 mm respectively. The axial stress (σ_{A}) in MPa at position I in (68) for ΔT_{EFF} values of 200° C. and 300° C. is 125 and 81 respectively. Where ΔT is 0° C. (not in accordance with the present disclosure), the axial stress at I is 246 MPa. The hoop stress (σ_{H}) in MPa at position II in (68) for ΔT_{EFF} values of 200° C. and 300° C. is −155 and −99 respectively. Where ΔT is 0° C., the axial stress at II is −297 MPa. In accordance with the present disclosure, there is a substantial reduction in the magnitude of residual stresses and related deformations in brazed assemblies including materials with different coefficients of thermal expansion.

FIG. 27 depicts in cross section, a brazed assembly (69) in accordance with the present disclosure at an ambient or low temperature; (69) is rotationally symmetrical about (31) and includes a SCD outer body (70) with a characterising dimension t1 and with a first coefficient of expansion α1=3.5e-6 K⁻¹; an inner body (71) with a second coefficient of expansion α2=8.0e-6 K⁻¹ and dimensions R₁=1.7 mm, R_{Aa}=10 mm, t, =1.5 mm, R_{Ba}≈2.0 mm, θ=45° and g_{R}=0.2 mm. The Young's modulus values for the first and second materials are 750 GPa and 450 GPa respectively. The inner body (71) may include a vent (72) to facilitate the escape of gases during the braze process and or the application of a vacuum. The resultant braze region of thickness g_{R} between (70) and (71) includes a braze alloy which is metallurgical bonded with each of the inner and outer bodies. Where ΔT=0° C. (not in accordance with the present disclosure), the hoop stress at positions I and II are 281 MPa and −562 MPa respectively. Where ΔT_{EFF}=150° C. (for which d₀_{_}_{EFF}=0.008 mm), the hoop stress at positions I and II are 64 MPa and −138 MPa respectively. For the assembly (69), (71) and (70) are directed towards each other during the cooling interval ΔT_{E}FF. For assembly (67), (28) and (68) are directed away from each other during the cooling interval ΔT_{EFF}.

Embodiments of the present disclosure may have outer and or inner bodies which are composed of a polycrystalline material; said material possibly comprising multiple discrete phases resolvable at high magnification. Embodiments may have outer and or inner bodies which macroscopically include more than one discrete material, each of said discrete materials possibly comprising multiple discrete phases on a microscopic scale. Other combinations of materials may be envisioned, such as gradient sintered cemented carbides or ceramics, coated cemented carbide or ceramics, bi- or multi-layer ceramic composites or structures of a laminate or annular construction for example. Said ceramics may include for example PCD, polycrystalline cubic boron nitride or boron carbide, alumina, titanium carbide, nitride or carbo-nitride, whisker-reinforced ceramics, sialon and silicon carbide. The inner body will have at least one substantially conical form on at least one of possibly several different materials from which it may be composed. For example, the region on which the conical form is disposed may be a structural steel or may be a high temperature alloy, which in turn may be metallurgically bonded or mechanically attached to other materials. Other embodiments are envisioned which include more than one conical form on an inner body material or a conical form of different apex angle on each of several materials comprising the inner body. Yet further embodiments may include electroless, electrolytic or vapour deposited coatings on conical forms and or conical recesses, such coatings being sub-micron to several tens of microns in thickness and which may enhance bonding.

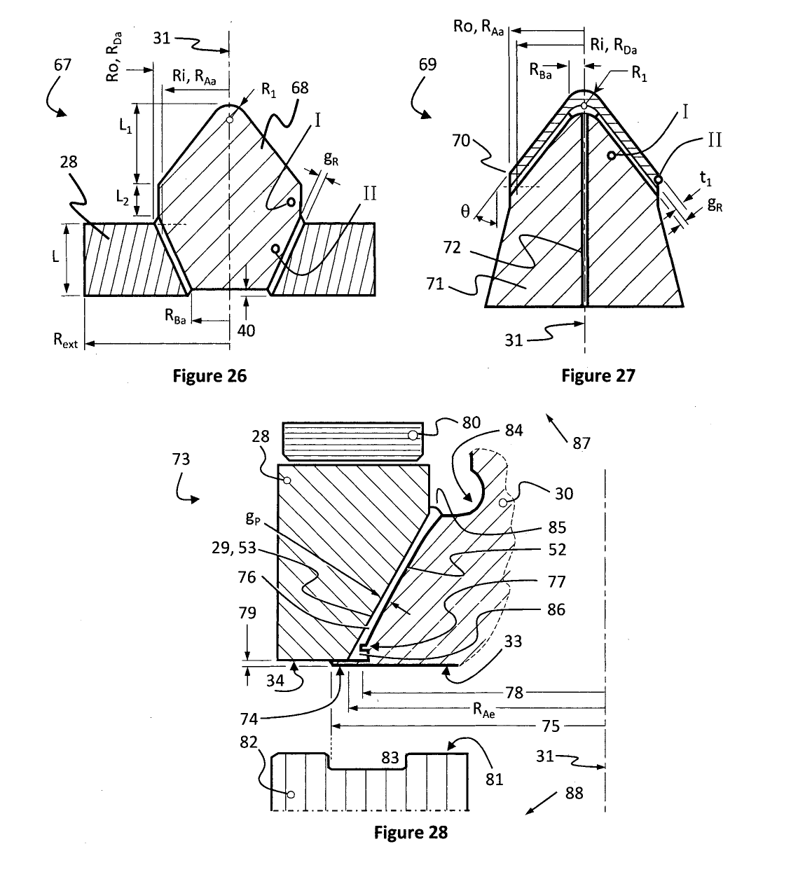

The pre-brazed assembly (73) in FIG. 28 is substantially rotationally symmetric about the axis (31) and comprises an outer body (28) with a lower coefficient of expansion than the inner body (30). Between the substantially conical recess (29) and the substantially conical form on (30) is a pre-braze region (76) of mean thickness gp; where gp is greater than the bond region thickness g or the resultant bond region thickness, gR in the final bonded assembly. Prior to (73) being heated to the braze temperature, the outer body (28) seats on seating flange (74) of outside radius (75) which is sufficiently large so as to ensure that at ambient and maximum braze temperature, it will exceed the largest radius (R_{Ae}) of the conical recess. A centering flange (77) of outside radius (78) is disposed on a rearward aspect of the conical form. The radius (78) is such that at ambient temperature, there is clearance between (77) and (29), while at the maximum braze temperature, there will be minimal or no clearance between (77) and (29). Flanges (74) and (77) may be notched so as to vent the pre-braze region (76). Flanges (74) and (77) may integral with (30) as shown, or may be integral with (28), or may be independently formed and secured to (28) or (30). Flange (74) has a thickness dimension (79) which may be equal to the axial displacement dimension d₀ or d₀_{_}_{EFF}. Eventually, once an interim bonded assembly is formed from (73), a load applied to the upper face of (28) through the upper die (80) will cause the lower face (33) of (30) to bear against the upper face (81) of (82). The lower die recess (83) receives (74) as it is deformed. As the cumulative axial displacement approaches d₀ or d₀_{_}_{EFF}, the lower face (34) of (28) will impinge against (81). In certain embodiments of the present disclosure, the dies (80) and (82) may be heated and or thermally insulating washers may be inserted between (80) and (28) and (30) and (82) to limit the cooling rate of the interim brazed assembly. The circular groove (84) may hold a braze ring adjacent the pre-braze region (76). Alternatively, a braze foil, paste or powder and or braze flux may be disposed within (76). The forward pre-braze region extremity (85) and the rearward pre-braze region extremity (86) are towards the forward end of the pre-brazed assembly (87) and the rearward end of the pre-brazed assembly (88) respectively.

FIG. 29 depicts an embodiment of the present disclosure in which the interim brazed assembly (89) includes an outer body (90) with a lower coefficient of thermal expansion than the inner body (91). The temperature of (89) is T_{S} and a braze joint exists between the apposing conical aspects of (90) and (91). The centering flange (92) is sized so as to maintain alignment of the bodies at the melting temperature of the braze alloy as is (77) in (73). Any flux and or gasses may escape via the circumferential vent groove (93) and vent holes (94). The outer body (90) rests on the metal compression ring (95) which protrudes above the upper face of the seat flange (96) by an amount d₀ or d₀_{_}_{EFF}. During progressive displacement in the direction of the axis (31) of (90) relative to (91) as the interim brazed assembly cools over a temperature interval ΔT or ΔT_{EFF}, the compression ring (95) is substantially plastically compressed or crushed permitting the outer body to eventually seat on (96). The heat insulting washer (97) insulates (89) from the dies effecting the displacement forces (98) and may for example be titanium, stainless steel or ceramic. The compression ring (95) may be any metal or ceramic. The ball (99) seats on (91) and bears against the indicator probe (100) for measurement of Z1; said probe arm normal said axis (31). Alternatively, displacement measurement of dimension Z2 may use the displacement probe (101) which may be particularly insensitive to thermal expansion-related measurement errors. Both measuring devices may employ the upper face of (97) as their datum. Instantaneous dimensions Z1 and Z2 and temperature of (89) as it cools over the temperature interval ΔT or ΔT_{EFF}, enables the relative axial displacement between (90) and (91) to be determined. Said displacement may be determined for example at the centroid (102) of the braze joint. Accounting for the thermal deformation of at least (90), (91), (97) and (99) may improve dimensional measurements.

Embodiments in accordance with the present disclosure may include, in addition to braze alloys, foils, fibres, wires or particles within the braze region (32, 36). These may include copper, molybdenum or other metals or alloys which may have a low recrystallization temperature. Such foils, fibres, wires or particles remain as a solid phase at the braze or bonding temperature, and may facilitate relatively larger braze region thickness values, as may be required when brazing relatively large assemblies. For example, the braze region thickness, g or g_{R}, may be at least 0.1 mm or more preferably, may be at least 0.2 mm. In such embodiments, the shear deformation which counteracts the volumetric mismatch otherwise occurring, may be accommodated substantially or partly within said foils, fibres, wires or particles. Accordingly, said foils, fibres, wires or particles within the braze region (32) will exhibit a characteristic microstructure in which constituent grains exhibit an alignment relative to the generatrices (52), (53) and axis (31) of the brazed assembly which will be substantially the same as that disclosed in relation to braze regions containing a braze alloy only. Whereas plastically deformed braze alloys in accordance with the present disclosure may be characterised in terms of the alignment of primary a-phase grains, for example, relative to (52), (53) and or axis (31); foils, fibres, wires or particles may be characterised, at least for the purposes of convenience, by reference to the alignment of grains of the phase therein with the highest volume fraction.

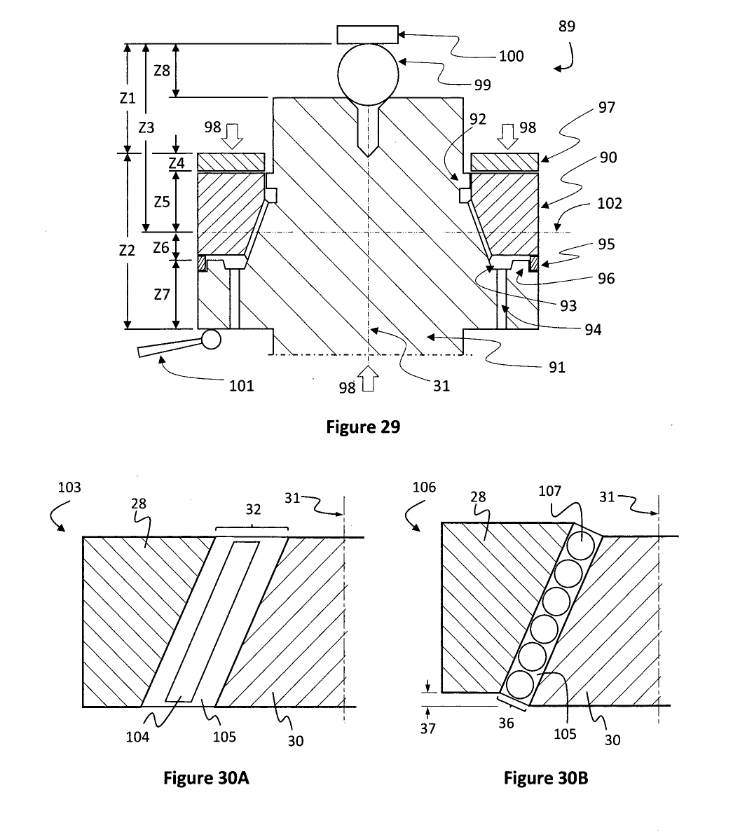

In FIG. 30A, a cross section view of a brazed assembly at ambient temperature (103) in accordance with the present disclosure has an inner body (30) including a conical form and an outer body (28) with a conical recess. A braze region (32) lies between the conical aspects of the inner and outer bodies and includes a metal foil (104) and a braze alloy (105); said foil substantially within or bounded by said braze alloy (105); said foil (104) substantially rotationally symmetrical about axis (31) and substantially conformal with the conical recess and conical form of the outer and inner bodies respectively. The precursor to the foil (104) within an interim braze assembly will be plastically sheared simultaneous with cooling of the assembly. In FIG. 30B, the interim brazed assembly (106) is at an elevated temperature and includes an inner body which is axially offset (37) relative to the outer body (28). The braze region (36) of (106) includes at least one metal wire (107) which may for example be wound around the conical form of the inner body (30) prior to assembly of (106)—said wire configuration showing as a series of co-linear circles in cross section. As (106) is cooled from said elevated temperature, the offset (37) is progressively reduced in proportion to the instantaneous temperature of (106) so as to ensure that the volume of the braze region (36) contracts by an amount substantially equal to, or proportional to the net contraction of the braze alloy (105) and the metal wire (107) combined. Braze regions (32, 36) or more generally, the bond region may alternatively or additionally include a plurality of hard particles or fibres such as tungsten carbide, carbon fibre and or coated or uncoated ceramic or diamond for example, which may be substantially uniformly distributed throughout the bond region so as to improve its wear resistance and or to lower its mean coefficient of thermal expansion.

Brazing and bonding processes in accordance with the present disclosure may include for example furnace heating, gas torch heating, laser or electron beam and or induction heating. The use of air, vacuum, reducing or inert atmospheres will be within the scope of the present disclosure.

It will be understood that the invention is not limited to the specific details described herein which are given by way of example only and that various modifications and alterations are possible without departing from the scope of the invention as defined in the appended claims.

1. A bonded assembly (25, 39, 44, 51, 55, 61, 62, 67, 69, 103) with a forward end (26) and a rearward end (27) and including at least an inner body (30, 60, 66, 68, 71), an outer body (28, 41, 59, 63, 70) and a bond region (32);
said inner body (30, 60, 66, 68, 71) including a substantially conical form, said conical form having a forward end and a first apex angle 2.θ towards said forward end (26) of said bonded assembly (25, 39, 44, 51, 55, 61, 62, 67, 69, 103), a rearward end, a first set of generatrices (52) and a first cone axis (31) extending in an axial direction, said conical form in a first material having a mean coefficient of thermal expansion α1 and a first solidus temperature;
said outer body (28, 41, 59, 63, 70) including a substantially conical recess (29), said conical recess (29) having a forward end and a second apex angle towards said forward end (26) of said bonded assembly (25, 39, 44, 51, 55, 61, 62, 67, 69, 103), a rearward end, a second set of generatrices (53) and a second cone axis substantially parallel with said first cone axis (31), said conical recess (29) in a second material having a mean coefficient of thermal expansion α2 and a second solidus temperature;
whereby said forward end of said conical form is forward said rearward end of said conical recess (29) and said forward end of said conical recess (29) is forward said rearward end of said conical form;
said bond region (32) having a mean bond region thickness g or g_{R}, and including at least a third material, said third material being a metal or metal alloy including at least one phase, said at least one phase including a plurality of grains; said third material substantially apposing and metallurgically bonded to at least part of said conical recess (29) and to at least part of said conical form;
whereby each of at least one radial plane P of said bonded assembly (25, 39, 44, 51, 55, 61, 62, 67, 69, 103) is a plane in which lies said first cone axis (31), one of said first set of generatrices (52) and one of said second set of generatrices (53); the mean distance from said one of said first set of generatrices (52) lying in said radial plane P to said one of said second set of generatrices (53) lying in said radial plane P being said mean bond region thickness g or g_{R} whereby g or g_{R} is not less than about 0.025 mm;
whereby q and m are integers independently greater than or equal to one and whereby the product of q and m is at least 20; for each of an isotropic set of q said radial planes P independently, there is a set of m sectioned grains (57), each of said sectioned grains (57) independently having an intercept area A whereby said intercept area A is the area of intersection of one of said grains with said radial plane P; said set of q radial planes P having a uniform angular spacing ψ when viewed parallel to said first cone axis (31); said intercept area A having a centroid (58);
whereby for each of said m sectioned grains (57) independently, there exists a value p and a set of 180 intercept lengths Lₙᵢ, each of said intercept lengths Lₙᵢ being the distance over which a corresponding member of an isotropic set of intercept lines nᵢ lying in said radial plane P is coincident with said intercept area A; each of said intercept lines nᵢ extending through said centroid (58) and subtending an angle βᵢ with said first cone axis (31); whereby 0°βᵢ≤180° and where βᵢ≤90°, said intercept line nᵢ extends towards said first cone axis (31) as it extends in a direction from said centroid (58) to said forward end (26) of said bonded assembly (25, 39, 44, 51, 55, 61, 62, 67, 69, 103); said isotropic set of intercept lines nᵢ having a uniform angular spacing Ω within said radial plane P; said set of 180 intercept lengths Lₙᵢ having a maximum intercept length L_{n max};
whereby for each of said sets of 180 intercept lengths Lₙᵢ, said member of said isotropic set of intercept lines nᵢ corresponding to said maximum intercept length L_{n max} subtends an angle βi=ρ with said first cone axis (31);
whereby a set comprising said value ρ for each of said m sectioned grains (57) within each of said q radial planes P has a median ρ_{R}, a first quartile ρ_{R1} and a third quartile ρ_{R3}; said median ρ_{R} being the median grain alignment relative to said first cone axis (31) within said bonded assembly (25, 39, 44, 51, 55, 61, 62, 67, 69, 103), said first quartile ρ_{R1} and said third quartile ρ_{R3} defining the distribution (ρ_{R3}−ρ_{R1}) of said grain alignments ρ in said bond region (32);
such that the quantity (ρ_{R3}−ρ_{R}i) is not substantially greater than about 80° and where α1>α2, the quantity (ρ_{R}−θ) lies substantially within the range 10° to 70° or where α2>α1, the quantity (ρ_{R}−θ) lies substantially within the range 110° to 170°.

2. The bonded assembly (25, 39, 44, 51, 55, 61, 62, 67, 69, 103) as claimed in claim 1 whereby 20°≤2.θ≤120° and whereby said third material is a braze alloy (105) having a liquidus temperature, such that said liquidus temperature is lower than both said first solidus temperature and said second solidus temperature.

3. The bonded assembly (25, 39, 44, 51, 55, 61, 62, 67, 69, 103) as claimed in claim 2 such that where α1>α2, said quantity (ρ_{R}−θ) lies substantially within the range 10° to 45° or where α2>α1, said quantity (ρ_{R}−θ) lies substantially within the range 135° to 170°; said quantity (ρ_{R3}−ρ_{R1}) is not substantially greater than about 70°.

4. The bonded assembly (25, 39, 44, 51, 55, 61, 62, 67, 69, 103) as claimed in claim 1 wherein the bond region thickness g or g_{R} is not substantially less than about 0.1 mm; whereby said bond region (32) includes a fourth material with a fourth solidus temperature, said fourth solidus temperature at least about 20° C. higher than said liquidus temperature.

5. The bonded assembly (25, 39, 44, 51, 55, 61, 62, 67, 69, 103) as claimed in claim 4 whereby said fourth material is a foil (104) or a wire (107), said foil (104) or said wire (107) substantially rotationally symmetrical about said first cone axis (31) and substantially conformal with both said conical form and said conical recess (29), said foil (104) or said wire (107) substantially bounded by and metallurgically bonded to said braze alloy (105).

6. The bonded assembly (25, 39, 44, 51, 55, 61, 62, 67, 69, 103) as claimed in claim 5 whereby 30°≤2.θ≤90° and said second apex angle is equal to said first apex angle 2.θ.

7. The bonded assembly (25, 39, 44, 51, 55, 61, 62, 67, 69, 103) as claimed in claim 7 whereby said fourth material has a preferred slip plane family such that within any of said radial plane P, said preferred slip plane family has a median orientation relative to said one of said first set of generatrices (52) lying in said radial plane P, whereby said median orientation of said preferred slip plane family is within +/−35° of said one of said first set of generatrices (52) lying in said radial plane P.

8. The bonded assembly (25, 39, 44, 51, 55, 61, 62, 67, 69, 103) as claimed in claim 7, whereby either or both said first material and or said second material includes a ceramic.

9. The bonded assembly (25, 39, 44, 51, 55, 61, 62, 67, 69, 103) as claimed in claim 8, whereby either or both said first material and or said second material includes diamond.

10. The bonded assembly (25, 39, 44, 51, 55, 61, 62, 67, 69, 103) as claimed in claim 4 whereby said fourth material is a plurality of particles and or fibres distributed within said bond region (32).

11. A method for manufacturing a bonded assembly (25, 39, 44, 51, 55, 61, 62, 67, 69, 103) operable within a service temperature range and having a forward end (26), a rearward end (27) and a bond region (32), said method comprising:
forming an inner body (30, 60, 66, 68, 71) including a substantially conical form having a forward end and a rearward end, said conical form having a first cone axis (31), a first set of generatrices (52) and a first base radius Ri extending in a direction normal to said first cone axis (31), said conical form having toward said forward end a first apex having a first apex angle 2.θ, said conical form in a first material having a mean coefficient of thermal expansion αi and a first solidus temperature;
forming an outer body (28, 41, 59, 63, 70) including a substantially conical recess (29) with a forward end and a rearward end, said conical recess (29) having a second cone axis, a second set of generatrices (53) and a second base radius Ro extending in a direction normal to said second cone axis, said conical recess (29) having toward said forward end a second apex having a second apex angle, said conical recess (29) in a second material having a mean coefficient of thermal expansion αo and a second solidus temperature;
assembling said inner body (30, 60, 66, 68, 71) and said outer body (28, 41, 59, 63, 70) at a first ambient temperature forming a pre-bonded assembly (73), wherein said first cone axis (31) and said second cone axis are substantially parallel and said first apex and said second apex are towards a forward end (87) of said pre-bonded assembly (73); said pre-bonded assembly (73) including a pre-bond region (76) between said first set of generatrices (52) and said second set of generatrices (53) and substantially between a forward pre-bond region extremity (85) and a rearward pre-bond region extremity (86); said pre-bond region (76) having a mean pre-bond region thickness g_{P} where g_{P} is greater than a value g; said assembling of said inner body (30, 60, 66, 68, 71) and said outer body (28, 41, 59, 63, 70) including disposing within or adjacent said pre-bond region (76) at least a third material with a third solidus temperature T_{Sol} and a coefficient of thermal expansion αb;
heating said pre-bonded assembly (73) to a maximum bonding process temperature Tₘₐₓ, retaining within said pre-bond region (76) at least part of said third material, establishing a metallurgical bond between said third material and said first material and between said third material and said second material; thereby forming an interim bonded assembly (35, 38, 45, 89);
forming said bonded assembly (25, 39, 44, 51, 55, 61, 62, 67, 69, 103) by cooling said interim bonded assembly (35, 38, 45, 89) from a start temperature Ts to an end temperature T_{E} and simultaneously axially displacing said inner body (30, 60, 66, 68, 71) relative to said outer body (28, 41, 59, 63, 70); said axial displacement substantially parallel to said first axis (31) and having a direction of axial displacement and a maximum cumulative displacement d₀_{_}_{EFF} at said end temperature T_{E};
whereby
$${d}_{0 \_ EFF} = ( \frac{{g}_{R} . ( Rit + Rot ) . \sqrt{1 + \frac{1}{{tan}^{2} θ}}}{( Rit + Rot + Δ {T}_{EFF} . ( Rit . α i + Rot . α o ) ) . ( 1 + \frac{Δ {T}_{EFF} . ( α o + α i )}{2} )} ) - \frac{Rot . ( 1 + α o . Δ {T}_{EFF} )}{tan θ} + \frac{Rit . ( 1 + α i . Δ {T}_{EFF} )}{tan θ} ;$$
whereby if Ro>Ri+g/cos θ; Rot=Ri+g/cos θ and Rit=Ri; and whereby alternatively if Ri>Ro−g/cos θ; Rit=Ro−g/cos θ and Rot=Ro;
whereby said ΔT_{EFF} is a temperature interval defined by said start temperature T_{S} and said end temperature T_{E} whereby ΔT_{EFF}=T_{S}−T_{E}; said start temperature Ts not substantially greater than the minimum of said third solidus temperature T_{Sol} and said maximum bonding process temperature Tₘₐₓ; said end temperature T_{E} not substantially less than said second ambient temperature Tₐ;
said bonded assembly (25, 39, 44, 51, 55, 61, 62, 67, 69, 103) having a forward end (26) formed from said forward end (87) of said pre-bonded assembly (73) and including a bond region (32) with a mean bond region thickness g_{R}, whereby g_{R}≈g+(d₀−d₀_{_}_{EFF})·sin(θ);
whereby
$${d}_{0} = ( \frac{g . ( Rit + Rot ) . \sqrt{1 + \frac{1}{{tan}^{2} θ}}}{( Rit + Rot + Δ T . ( Rit . α i + Rot . α o ) ) . ( 1 + \frac{Δ T . ( α o + α i )}{2} )} ) - \frac{Rot . ( 1 + α o . Δ T )}{tan θ} + \frac{Rit . ( 1 + α i . Δ T )}{tan θ} ;$$
whereby said ΔT is a temperature interval defined by said second ambient temperature Tₐ and said minimum of said third solidus temperature T_{Sol} and said maximum bonding process temperature Tₘₐₓ; whereby said second ambient temperature Tₐ<T_{Sol} and Tₐ<Tₘₐₓ;
whereby if αi is less than αo, said direction of axial displacement is such that said rearward end of said inner body (30, 60, 66, 68, 71) is made more distal said forward end of said outer body (28, 41, 59, 63, 70) and whereby if αi is greater than αo, said direction of axial displacement is such that said rearward end of said inner body (30, 60, 66, 68, 71) is made more proximal said forward end of said outer body (28, 41, 59, 63, 70);
such that said maximum cumulative displacement d₀_{_}_{EFF} is at least about 20% of d₀ and g_{R} and g is not substantially less than about 0.025 mm.

12. The method as claimed in claim 11 whereby said third material included in said bond region (32) of said bonded assembly (25, 39, 44, 51, 55, 61, 62, 67, 69, 103) is a braze alloy (105) having a liquidus temperature, such that said liquidus temperature is lower than both said first solidus temperature and said second solidus temperature.

13. The method as claimed in claim 12 wherein said pre-bond region (76) includes a fourth material having a fourth solidus temperature at least about 20° C. higher than said liquidus temperature.

14. The method as claimed in claim 13 whereby said fourth material is a foil (104) or a wire (107), said foil (104) or said wire (107) substantially rotationally symmetrical about said first cone axis (31) and substantially conformal with said conical form and said conical recess (29);

15. The method as claimed in claim 14 wherein said first ambient temperature is about 20° C. and said second ambient temperature is any temperature between about 20° C. and any temperature within said service temperature range.

16. The method as claimed in claim 15 whereby said first apex angle 2.θ is substantially within the range 20°≤2.θ≤120°, whereby said second apex angle is substantially equal to said first apex angle and whereby d₀_{_}_{EFF} is not substantially greater than about 1.3·(d₀·(ΔT_{EFF}/ΔT)).

17. The method as claimed in claim 16 whereby d₀_{_}_{EFF} is at least about 50% of d₀.

18. The method as claimed in claim 17, whereby said first material and or said second material includes a ceramic material or a diamond material.

19. The method as claimed in claim 18 whereby d₀_{_}_{EFF} is at least about 70% of d₀ and whereby d₀_{_}_{EFF} is not substantially greater than about 1.1·(d₀·(ΔT_{EFF}/ΔT)).

20. The method as claimed in claim 13 whereby said displacement d₀_{_}_{EFF} is measured with an indicator probe (100) substantially normal to said first cone axis and said pre-bonded assembly (73) or said bonded assembly (25, 39, 44, 51, 55, 61, 62, 67, 69, 103) including a compression ring (95) or seating flange (74) and or centering flange (86, 92).
